(19) United States
(12) Patent Application Publication
(10) Pub. No.: US 2026/0140726 A1
(43) Pub. Date: May 21, 2026

(54) APPARATUS, SYSTEM, AND METHOD OF COMPILING CODE FOR A PROCESSOR

(71) Applicant: MobilEye Vision Technologies Ltd., Jerusalem (IL)

(72) Inventor: Michael ZUCKERMAN, Har Adar (IL)

(73) Assignee: MobilEye Vision Technologies Ltd., Jerusalem (IL)

(21) Appl. No.: 19/119,485

(22) PCT Filed: Oct. 12, 2023
(86) PCT No.: PCT/IB2023/060314

§ 371 Date: Apr. 9, 2025

Related U.S. Application Data
(60) Provisional application No. 63/415,310, filed on Oct. 12, 2022.

(51) Int. Cl. G06F 8/41

(52) U.S. Cl. CPC G06F 8/447; G06F 8/434

(57) ABSTRACT

For example, a compiler may be configured to identify a plurality of memory-access operations in a loop based on a source code to be compiled into a target code to be executed by a target processor, the plurality of memory-access operations may include at least a first memory-access operation and a second memory-access operation to a same memory pointer. For example, the first memory-access operation may have a first offset, and the second memory-access operation may have a second offset different from the first offset. For example, the compiler may configure Address Generation Unit (AGU) configuration code to configure the plurality of memory-access operations by a same AGU. For example, the compiler may generate the target code based on compilation of the source code. For example, the target code may be based on the AGU configuration code.

### CROSS REFERENCE

This application claims the benefit of and priority from U.S. Provisional Patent Application No. 63/415,310 entitled “APPARATUS, SYSTEM, AND METHOD OF VECTOR PROCESSING”, filed Oct. 12, 2022, the entire disclosure of which is incorporated herein by reference.

### BACKGROUND

A compiler may be configured to compile source code into target code configured for execution by a processor.

There is a need to provide a technical solution to support efficient processing functionalities.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a compiler, in accordance with some demonstrative aspects.

FIG. 3 is a schematic illustration of a vector processor, in accordance with some demonstrative aspects.

FIG. 4 is a schematic illustration of a memory access scheme to load data from a memory with respect to a memory pointer, in accordance with some demonstrative aspects.

FIG. 5 is a schematic illustration of a memory access scheme to load data from a memory with respect to a memory pointer, in accordance with some demonstrative aspects.

FIG. 6 is a schematic flow-chart illustration of a method of compiling code for a processor, in accordance with some demonstrative aspects.

FIG. 7 is a schematic illustration of a product, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may be used in conjunction with various devices and systems, for example, a computing device, a computer, a mobile computer, a non-mobile computer, a server computer, or the like.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., processor circuitry, control circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

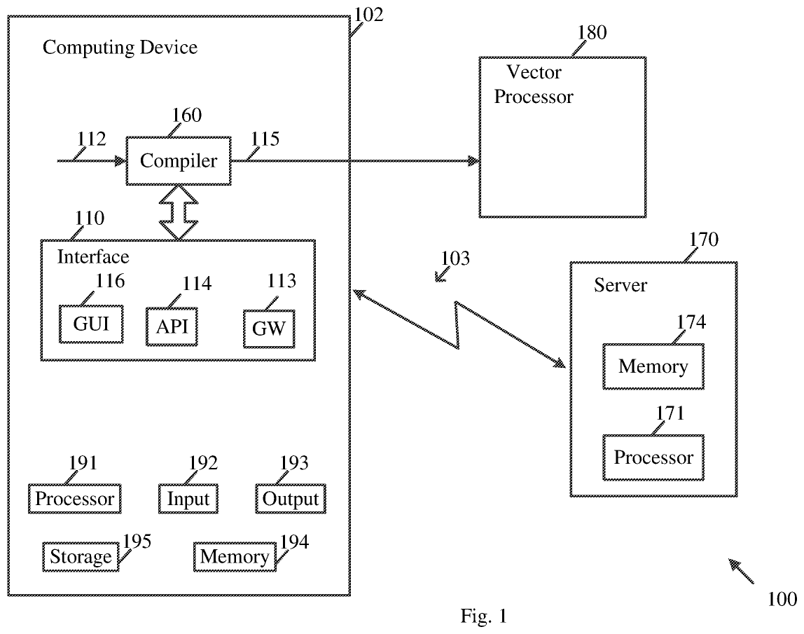

Reference is now made to FIG. 1, which schematically illustrates a block diagram of a system 100, in accordance with some demonstrative aspects.

As shown in FIG. 1, in some demonstrative aspects system 100 may include a computing device 102.

In some demonstrative aspects, device 102 may be implemented using suitable hardware components and/or software components, for example, processors, controllers, memory units, storage units, input units, output units, communication units, operating systems, applications, or the like.

In some demonstrative aspects, device 102 may include, for example, a computer, a mobile computing device, a non-mobile computing device, a laptop computer, a notebook computer, a tablet computer, a handheld computer, a Personal Computer (PC), or the like.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of one or more of device 102 may be enclosed in a common housing or packaging, and may be interconnected or operably associated using one or more wired or wireless links. In other aspects, components of one or more of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 may include, for example, a hard disk drive, a Solid State Drive (SSD), or other suitable removable or non-removable storage units. Memory unit 194 and/or storage unit 195, for example, may store data processed by device 102.

In some demonstrative aspects, device 102 may be configured to communicate with one or more other devices via at least one network 103, e.g., a wireless and/or wired network.

In some demonstrative aspects, network 103 may include a wired network, a local area network (LAN), a wireless network, a wireless LAN (WLAN) network, a radio network, a cellular network, a WiFi network, an IR network, a Bluetooth (BT) network, and the like.

In some demonstrative aspects, device 102 may be configured to perform and/or to execute one or more operations, modules, processes, procedures and/or the like, e.g., as described herein.

In some demonstrative aspects, device 102 may include a compiler 160, which may be configured to generate a target code 115, for example, based on a source code 112, e.g., as described below.

In some demonstrative aspects, compiler 160 may be configured to translate the source code 112 into the target code 115, e.g., as described below.

In some demonstrative aspects, compiler 160 may include, or may be implemented as, software, a software module, an application, a program, a subroutine, instructions, an instruction set, computing code, words, values, symbols, and/or the like.

In some demonstrative aspects, the source code 112 may include computer code written in a source language.

In some demonstrative aspects, the source language may include a programing language. For example, the source language may include a high-level programming language, for example, such as, C language, C++ language, and/or the like.

In some demonstrative aspects, the target code 115 may include computer code written in a target language.

In some demonstrative aspects, the target language may include a low-level language, for example, such as, assembly language, object code, machine code, or the like.

In some demonstrative aspects, the target code 115 may include one or more object files, e.g., which may create and/or form an executable program.

In some demonstrative aspects, the executable program may be configured to be executed on a target computer. For example, the target computer may include a specific computer hardware, a specific machine, and/or a specific operating system.

In some demonstrative aspects, the executable program may be configured to be executed on a processor 180, e.g., as described below.

In some demonstrative aspects, processor 180 may include a vector processor 180, e.g., as described below. In other aspects, processor 180 may include any other type of processor.

Some demonstrative aspects are described herein with respect to a compiler, e.g., compiler 160, configured to compile source code 112 into target code 115 configured to be executed by a vector processor 180, e.g., as described below. In other aspects, a compiler, e.g., compiler 160, configured to compile source code 112 into target code 115 configured to be executed by any other type of processor 180.

In some demonstrative aspects, processor 180 may be implemented as part of device 102.

In other aspects, processor 180 may be implemented as part of any other device, e.g., separate from device 102.

In some demonstrative aspects, vector processor 180 (also referred to as an “array processor”) may include a processor, which may be configured to process an entire vector in one instruction, e.g., as described below.

In other aspects, the executable program may be configured to be executed on any other additional or alternative type of processor.

In some demonstrative aspects, the vector processor 180 may be designed to support high-performance image and/or vector processing. For example, the vector processor 180 may be configured to processes 1/2/3/4D arrays of fixed point data and/or floating point arrays, e.g., very quickly and/or efficiently.

In some demonstrative aspects, the vector processor 180 may be configured to process arbitrary data, e.g., structures with pointers to structures. For example, the vector processor 180 may include a scalar processor to compute the non-vector data, for example, assuming the non-vector data is minimal.

In some demonstrative aspects, compiler 160 may be implemented as a local application to be executed by device 102. For example, memory unit 194 and/or storage unit 195 may store instructions resulting in compiler 160, and/or processor 191 may be configured to execute the instructions resulting in compiler 160 and/or to perform one or more calculations and/or processes of compiler 160, e.g., as described below.

In other aspects, compiler 160 may include a remote application to be executed by any suitable computing system, e.g., a server 170.

In some demonstrative aspects, server 170 may include at least a remote server, a web-based server, a cloud server, and/or any other server.

In some demonstrative aspects, the server 170 may include a suitable memory and/or storage unit 174 having stored thereon instructions resulting in compiler 160, and a suitable processor 171 to execute the instructions, e.g., as descried below.

In some demonstrative aspects, compiler 160 may include a combination of a remote application and a local application.

In one example, compiler 160 may be downloaded and/or received by the user of device 102 from another computing system, e.g., server 170, such that compiler 160 may be executed locally by users of device 102. For example, the instructions may be received and stored, e.g., temporarily, in a memory or any suitable short-term memory or buffer of device 102, e.g., prior to being executed by processor 191 of device 102.

In another example, compiler 160 may include a client-module to be executed locally by device 102, and a server module to be executed by server 170. For example, the client-module may include and/or may be implemented as a local application, a web application, a web site, a web client, e.g., a Hypertext Markup Language (HTML) web application, or the like.

For example, one or more first operations of compiler 160 may be performed locally, for example, by device 102, and/or one or more second operations of compiler 160 may be performed remotely, for example, by server 170.

In other aspects, compiler 160 may include, or may be implemented by, any other suitable computing arrangement and/or scheme.

In some demonstrative aspects, system 100 may include an interface 110, e.g., a user interface, to interface between a user of device 102 and one or more elements of system 100, e.g., compiler 160.

In some demonstrative aspects, interface 110 may be implemented using any suitable hardware components and/or software components, for example, processors, controllers, memory units, storage units, input units, output units, communication units, operating systems, and/or applications.

In some aspects, interface 110 may be implemented as part of any suitable module, system, device, or component of system 100.

In other aspects, interface 110 may be implemented as a separate element of system 100.

In some demonstrative aspects, interface 110 may be implemented as part of device 102. For example, interface 110 may be associated with and/or included as part of device 102.

In one example, interface 110 may be implemented, for example, as middleware, and/or as part of any suitable application of device 102. For example, interface 110 may be implemented as part of compiler 160 and/or as part of an OS of device 102.

In some demonstrative aspects, interface 110 may be implemented as part of server 170. For example, interface 110 may be associated with and/or included as part of server 170.

In one example, interface 110 may include, or may be part of a Web-based application, a web-site, a web-page, a plug-in, an ActiveX control, a rich content component, e.g., a Flash or Shockwave component, or the like.

In some demonstrative aspects, interface 110 may be associated with and/or may include, for example, a gateway (GW) 113 and/or an Application Programming Interface (API) 114, for example, to communicate information and/or communications between elements of system 100 and/or to one or more other, e.g., internal or external, parties, users, applications and/or systems.

In some aspects, interface 110 may include any suitable Graphic-User-Interface (GUI) 116 and/or any other suitable interface.

In some demonstrative aspects, interface 110 may be configured to receive the source code 112, for example, from a user of device 102, e.g., via GUI 116, and/or API 114.

In some demonstrative aspects, interface 110 may be configured to transfer the source code 112, for example, to compiler 160, for example, to generate the target code 115, e.g., as described below.

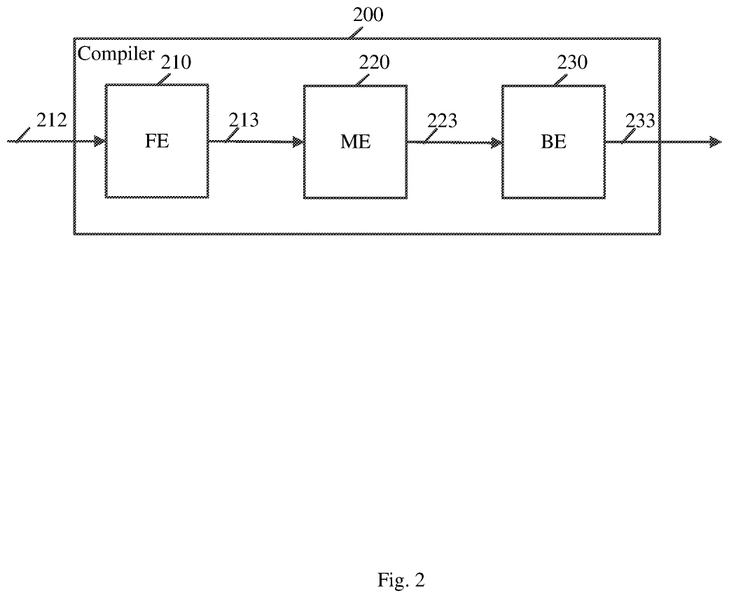

Reference is made to FIG. 2, which schematically illustrates a compiler 200, in accordance with some demonstrative aspects. For example, compiler 160 (FIG. 1) may be implement one or more elements of compiler 200, and/or may perform one or more operations and/or functionalities of compiler 200.

In some demonstrative aspects, as shown in FIG. 2, compiler 200 may be configured to generate a target code 233, for example, by compiling a source code 212 in a source language.

In some demonstrative aspects, as shown in FIG. 2, compiler 200 may include a front-end 210 configured to receive and analyze the source code 212 in the source language.

In some demonstrative aspects, front-end 210 may be configured to generate an intermediate code 213, for example, based on the source code 212.

In some demonstrative aspects, intermediate code 213 may include a lower level representation of the source code 212.

In some demonstrative aspects, front-end 210 may be configured to perform, for example, lexical analysis, syntax analysis, semantic analysis, and/or any other additional or alternative type of analysis, of the source code 212.

In some demonstrative aspects, front-end 210 may be configured to identify errors and/or problems with an outcome of the analysis of the source code 212. For example, front-end 210 may be configured to generate error information, e.g., including error and/or warning messages, for example, which may identify a location in the source code 212, for example, where an error or a problem is detected.

In some demonstrative aspects, as shown in FIG. 2, compiler 200 may include a middle-end 220 configured to receive and process the intermediate code 213, and to generate an adjusted, e.g., optimized, intermediate code 223.

In some demonstrative aspects, middle-end 220 may be configured to perform one or more adjustment, e.g., optimizations, to the intermediate code 213, for example, to generate the adjusted intermediate code 223.

In some demonstrative aspects, middle-end 220 may be configured to perform the one or more optimizations on the intermediate code 213, for example, independent of a type of the target computer to execute the target code 233.

In some demonstrative aspects, middle-end 220 may be implemented to support use of the optimized intermediate code 223, for example, for different machine types.

In some demonstrative aspects, middle-end 220 may be configured to optimize the intermediate representation of the intermediate code 223, for example, to improve performance and/or quality of the produced target code 233.

In some demonstrative aspects, the one or more optimizations of the intermediate code 213, may include, for example, inline expansion, dead-code elimination, constant propagation, loop transformation, parallelization, and/or the like.

In some demonstrative aspects, as shown in FIG. 2, compiler 200 may include a back-end 230 configured to receive and process the adjusted intermediate code 213, and to generate the target code 233 based on the adjusted intermediate code 213.

In some demonstrative aspects, back-end 230 may be configured to perform one or more operations and/or processes, which may be specific for the target computer to execute the target code 233. For example, back-end 230 may be configured to process the optimized intermediate code 213 by applying to the adjusted intermediate code 213 analysis, transformation, and/or optimization operations, which may be configured, for example, based on the target computer to execute the target code 233.

In some demonstrative aspects, the one or more analysis, transformation, and/or optimization operations applied to the adjusted intermediate code 213 may include, for example, resource and storage decisions, e.g., register allocation, instruction scheduling, and/or the like.

In some demonstrative aspects, the target code 233 may include target-dependent assembly code, which may be specific to the target computer and/or a target operating system of the target computer, which is to execute the target code 233.

In some demonstrative aspects, the target code 233 may include target-dependent assembly code for a processor, e.g., vector processor 180 (FIG. 1).

In some demonstrative aspects, compiler 200 may include a Vector Micro-Code Processor (VMP) Open Computing Language (OpenCL) compiler, e.g., as described below. In other aspects, compiler 200 may include, or may be implemented as part of, any other type of vector processor compiler.

In some demonstrative aspects, the VMP OpenCL compiler may include a Low Level Virtual Machine (LLVM) based (LLVM-based) compiler, which may be configured according to an LLVM-based compilation scheme, for example, to lower OpenCL C-code to VMP accelerator assembly code, e.g., suitable for execution by vector processor 180 (FIG. 1).

In some demonstrative aspects, compiler 200 may include one or more technologies, which may be required to compile code to a format suitable for a VMP architecture, e.g., in addition to open-sourced LLVM compiler passes.

In some demonstrative aspects, FE 210 may be configured to parse the OpenCL C-code and to translate it, e.g., through an Abstract Syntax Tree (AST), for example, into an LLVM Intermediate Representation (IR).

In some demonstrative aspects, compiler 200 may include a dedicated API, for example, to detect a correct pattern for compiler pattern matching, for example, suitable for the VMP. For example, the VMP may be configured as a Complex Instruction Set Computer (CISC) machine implementing a very complex Instruction Set Architecture (ISA), which may be hard to target from standard C code. Accordingly, compiler pattern matching may not be able to easily detect the correct pattern, and for this case the compiler may require a dedicated API.

In some demonstrative aspects, FE 210 may implement one or more vendor extension built-ins, which may target VMP-specific ISA, for example, in addition to standard OpenCL built-ins, which may be optimized to a VMP machine.

In some demonstrative aspects, FE 210 may be configured to implement OpenCL structures and/or work item functions.

In some demonstrative aspects, ME 220 may be configured to process LLVM IR code, which may be general and target-independent, for example, although it may include one or more hooks for specific target architectures.

In some demonstrative aspects, ME 220 may perform one or more custom passes, for example, to support the VMP architecture, e.g., as described below.

In some demonstrative aspects, ME 220 may be configured to perform one or more operations of a Control Flow Graph (CFG) Linearization analysis, e.g., as described below.

In some demonstrative aspects, the CFG Linearization analysis may be configured to linearize the code, for example, by converting if-statements to select patterns, for example, in case VMP vector code does not support standard control flow. In one example, ME 220 may receive a given code, e.g., as follows:

```
If (x > 0) {
  A = A + 5;
} else {
  B = B * 2;
}
```

According to this example, ME 220 may be configured to apply the CFG Linearization analysis to the given code, e.g., as follows:

$$tmpA = A + 5 ;$$

$$tmpB = B * 2 ;$$

$$mask = x > 0 ;$$

$$A = Select mask , tmpA , A$$

$$B = Select mask , tmpB , B$$

### Example (1)

In some demonstrative aspects, ME 220 may be configured to perform one or more operations of an auto-vectorization analysis, e.g., as described below.

In some demonstrative aspects, the auto-vectorization analysis may be configured to vectorize, e.g., auto-vectorize, a given code, e.g., to utilize vector capabilities of the VMP.

In some demonstrative aspects, ME 220 may be configured to perform the auto-vectorization analysis, for example, to vectorize code in a scalar form. For example, some or all operations of the auto-vectorization analysis may not be performed, for example, in case the code is already provided in a vectorized form.

In some demonstrative aspects, for example, in some use cases and/or scenarios, a compiler may not always be able to auto-vectorize a code, for example, due to data dependencies between loop iterations.

In one example, ME 220 may receive a given code, e.g., as follows:

char* a,b,c;
for (int i=0; i < 2048; i++) {
a[i]=b[i]+c[i];
}

According to this example, ME 220 may be configured to perform the CFG auto-vectorization analysis by applying a first conversion, e.g., as follows:

char* a,b,c;
for (int i=0; i < 2048; i+=32) {
a[i.i+31]=b[i...i+31]+c[i...i+31];
}

### Example (2a)

For example, ME 220 may be configured to perform the CFG auto-vectorization analysis by applying a second conversion, for example, following the first conversion, e.g., as follows:

char32* a,b,c;
for (int i=0; i < 64; i++) {
a[i]=b[i]+c[i];
}

### Example (2b)

In some demonstrative aspects, ME 220 may be configured to perform one or more operations of a Scratch Pad Memory Loop Access Analysis (SPMLAA), e.g., as described below.

In some demonstrative aspects, the SPMLAA may define Processing Blocks (PB), e.g., that should be outlined and compiled for VMP later.

In some demonstrative aspects, the processing blocks may include accelerated loops, which may be executed by the vector unit of the VMP.

In some demonstrative aspects, a PB, e.g., each PB, may include memory references. For example, some or all memory accesses may refer to local memory banks.

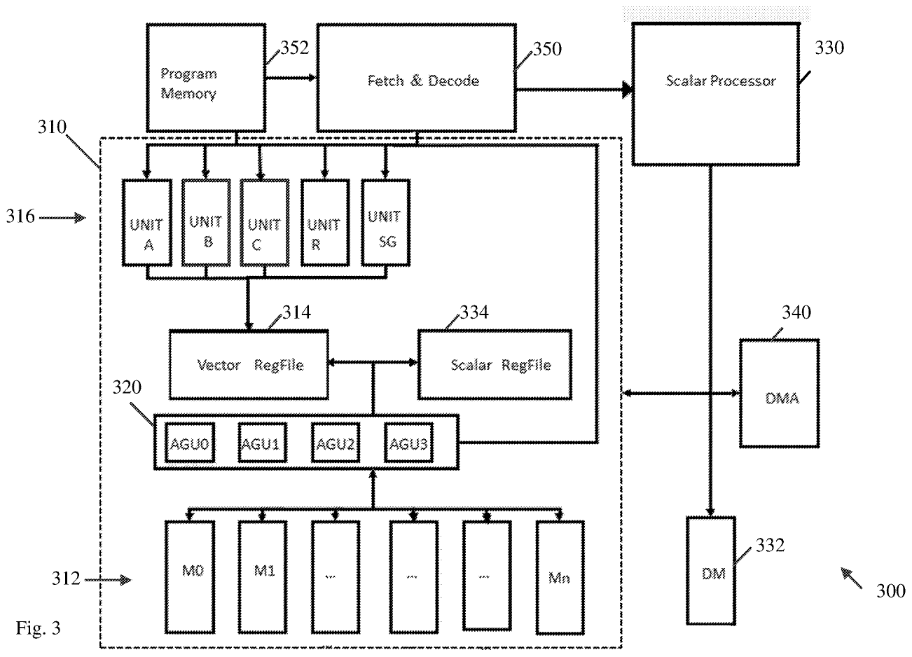

In some demonstrative aspects, the VMP may enable access to memory banks through AGUs, e.g., AGUs 320 as described below with reference to FIG. 3, and Scatter Gather units (SG).

In some demonstrative aspects, the AGUs may be pre-configured, e.g., before loop execution. For example, a loop trip count may be calculated, e.g., ahead of running a processing block.

In some demonstrative aspects, image references, e.g., some or all image references, may be created at this stage, and may be followed by calculation of strides and offsets, e.g., per dimension for each reference.

In some demonstrative aspects, ME 220 may be configured to perform one or more operations of an AGU planner analysis, e.g., as described below.

In some demonstrative aspects, the AGU Planner analysis may include iterator assignment, which may cover image references, e.g., all image references, from the entire Processing Block.

In some demonstrative aspects, an iterator may cover a single reference or a group of references.

In some demonstrative aspects, one or more memory references may be coalesced and/or reuse a same access through shuffle instructions, and/or saving values read from previous iterations.

In some demonstrative aspects, other memory references, e.g., which have no linear access pattern, may be handled using a Scatter-Gather (SG) unit, which may have a performance penalty, e.g., as it may require maintaining indices and/or masks.

In some demonstrative aspects, a plan may be configured as an arrangement of iterators in a processing block. For example, a processing block may have multiple plans, e.g., theoretically.

In some demonstrative aspects, the AGU Planner analysis may be configured to build all possible plans for all PBs, and to select a combination, e.g., a best combination, e.g., from all valid combinations.

In some demonstrative aspects, a total number of iterators in a valid combination may be limited, e.g., not to exceed a number of available AGUs on a VMP.

In some demonstrative aspects, one or more parameters, e.g., including stride, width and/or base, may be defined for an iterator, e.g., for each iterator for example, as part of the AGU Planner analysis. For example, min-max ranges for the iterators may be defined in a dimension, e.g., in each dimension, for example, as part of the AGU Planner analysis.

In some demonstrative aspects, the AGU Planner analysis may be configured to track and evaluate a memory reference, e.g., each memory reference, to an image, e.g., to understand its access pattern.

In one example, according to Examples 2a/2b, the image ‘a’ which is the base address, may be accessed with steps of 32 bytes for 64 iterations.

In some demonstrative aspects, the LLVM may include a scalar evaluation analysis (SCEV), which may compute an access pattern, e.g., to understand every image reference.

In some demonstrative aspects, ME 220 may utilize masking capabilities of the AGUs, for example, to avoid maintaining an induction variable, which may have a performance penalty.

In some demonstrative aspects, ME 220 may be configured to perform one or more operations of a rewrite analysis, e.g., as described below.

In some demonstrative aspects, the rewrite analysis may be configured to transform the code of a processing block, for example, while setting iterators and/or modifying memory access instructions.

In some demonstrative aspects, setting of the iterators, e.g., of all iterators, may be implemented in IR in target-specific intrinsics. For example, the setting of the iterators may reside in a pre-header of an outermost loop.

In some demonstrative aspects, the rewrite analysis may include loop-perfectization analysis, e.g., as described below.

In some demonstrative aspects, the code may be compiled with a target that substantially all calculations should be executed inside the innermost loop.

For example, the loop-perfectization analysis may hoist instructions, e.g., to move into a loop an operation performed after a last iteration of the loop.

For example, the loop-perfectization analysis may sink instructions, e.g., to move into a loop an operation performed before a first iteration of the loop.

For example, the loop-perfectization analysis may hoist instructions and/or sink instructions, for example, such that substantially all instructions are moved from outer loops to the innermost loops.

For example, the loop-perfectization analysis may be configured to provide a technical solution to support VMP iterators, e.g., to work on perfectly nested loops only.

For example, the loop-perfectization analysis may result in a situation where there are no instructions between the “for” statements that compose the loop, e.g., to support VMP iterators, which cannot emulate such cases.

In some demonstrative aspects, the loop-perfectization analysis may be configured to collapse a nested loop into a single collapsed loop.

In one example, ME 220 may receive a given code, e.g., as follows:

```
for (int i = 0; i < N; i++) {
  int sum = 0;
  for (int j = 0; j < M; j++)
  {
    sum += a[j + stride * i];
  }
    res[i] = sum;
}
```

According to this example, ME 220 may be configured to perform the loop-perfectization analysis to collapse the nested loop in the code to a single collapsed loop, e.g., as follows:

```
for (int k = 0; k < N * M; k++) {
  sum = (k % M == 0 ? 0 : sum);
  sum += a[k % M + stride * ( k / M )];
    res[k/M] = sum;
}
```

### Example (3)

In some demonstrative aspects, ME 220 may be configured to perform one or more operations of a Vector Loop Outlining analysis, e.g., as described below.

In some demonstrative aspects, the Vector Loop Outlining analysis may be configured to divide a code between a scalar subsystem and a vector subsystem, e.g., vector processing block 310 (FIG. 3) and scalar processor 330 (FIG. 3) as described below with reference to FIG. 3.

In some demonstrative aspects, the VMP accelerator may include the scalar and/or vector subsystems, e.g., as described below. For example, each of the subsystems may have different compute units/processors. Accordingly, a scalar code may be compiled on a scalar compiler, e.g., an SSC compiler, and/or an accelerated vector code may run on the VMP vector processor.

In some demonstrative aspects, the Vector Loop Outlining analysis may be configured to create a separate function for a loop body of the accelerated vector code. For example, these functions may be marked for the VMP and/or may continue to the VMP backend, for example, while the rest of the code may be compiled by the SSC compiler.

In some demonstrative aspects, one or more parts of a vector loop, e.g., configuration of the vector unit and/or initialization of vector registers, may be performed by a scalar unit. However, these parts may be performed in a later stage, for example, by performing backpatching into the scalar code, e.g., as the scalar code may still be in LLVM IR before processing by the SSC compiler.

In some demonstrative aspects, BE 230 may be configured to translate the LLVM IR into machine instructions. For example, the BE 230 may not be target agnostic and may be familiar with target-specific architecture and optimizations, e.g., compared to ME 220, which may be agnostic to a target-specific architecture.

In some demonstrative aspects, BE 230 may be configured to perform one or more analyses, which may be specific to a target machine, e.g., a VMP machine, to which the code is lowered, e.g., although BE 230 may use common LLVM.

In some demonstrative aspects, BE 230 may be configured to perform one or more operations of an instruction lowering analysis, e.g., as described below.

In some demonstrative aspects, the instruction lowering analysis may be configured to translate LLVM IR into target-specific instructions Machine IR (MIR), for example, by translating the LLVM IR into a Directed Acyclic Graph (DAG).

In some demonstrative aspects, the DAG may go through a legalization process of instructions, for example, based on the data types and/or VMP instructions, which may be supported by a VMP HW.

In some demonstrative aspects, the instruction lowering analysis may be configured to perform a process of pattern-matching, e.g., after the legalization process of instructions, for example, to lower a node, e.g., each node, in the DAG, for example, into a VMP-specific machine instruction.

In some demonstrative aspects, the instruction lowering analysis may be configured to generate the MIR, for example, after the process of pattern-matching.

In some demonstrative aspects, the instruction lowering analysis may be configured to lower the instruction according to machine Application Binary Interface (ABI) and/or calling conventions.

In some demonstrative aspects, BE 230 may be configured to perform one or more operations of a unit balancing analysis, e.g., as described below.

In some demonstrative aspects, the unit balancing analysis may be configured to balance instructions between VMP compute units, e.g., data processing units 316 (FIG. 3) as described below with reference to FIG. 3.

In some demonstrative aspects, the unit balancing analysis may be familiar with some or all available arithmetic transformations, and/or may perform transformations according to an optimal algorithm.

In some demonstrative aspects, BE 230 may be configured to perform one or more operations of a modulo scheduler (pipeliner) analysis, e.g., as described below.

In some demonstrative aspects, the pipeliner may be configured to schedule the instructions according to one or more constraints, e.g., data dependency, resource bottlenecks and/or any other constrains, for example, using Swing Modulo Scheduling (SMS) heuristics and/or any other additional and/or alternative heuristic.

In some demonstrative aspects, the pipeliner may be configured to schedule a set, e.g., an Initiation Interval (II), of Very Long Instruction Word (VLIW) instructions that the program will iterate on, e.g., during a steady state.

In some demonstrative aspects, a performance metric, which may be based on a number of cycles a typical loop may execute, may be measured, e.g., as follows:

$$( Size of Input data in bytes ) * II / ( Bytes consumed / produced every iteration )$$

In some demonstrative aspects, the pipeliner may try to minimize the II, e.g., as much as possible, for example, to improve performance.

In some demonstrative aspects, the pipeliner may be configured to calculate a minimum II, and to schedule accordingly. For example, if the pipeliner fails the scheduling, the pipeliner may try to increase the II and retry scheduling, e.g., until a predefined II threshold is violated.

In some demonstrative aspects, BE 230 may be configured to perform one or more operations of a register allocation analysis, e.g., as described below.

In some demonstrative aspects, the register allocation analysis may be configured to attempt to assign a register in an efficient, e.g., optimal, way.

In some demonstrative aspects, the register allocation analysis may assign values to bypass vector registers, general purpose vector registers, and/or scalar registers.

In some demonstrative aspects, the values may include private variables, constants, and/or values that are rotated across iterations.

In some demonstrative aspects, the register allocation analysis may implement an optimal heuristic that suites one or more VMP register file (regfile) constraints. For example, in some use cases, the register allocation analysis may not use a standard LLVM register allocation.

In some demonstrative aspects, in some cases, the register allocation analysis may fail, which may mean that the loop cannot be compiled. Accordingly, the register allocation analysis may implement a retry mechanism, which may go back to the modulo scheduler and may attempt to reschedule the loop, e.g., with an increased initiation interval. For example, increasing the initiation interval may reduce register pressure, and/or may support compilation of the vector loop, e.g., in many cases.

In some demonstrative aspects, BE 230 may be configured to perform one or more operations of an SSC configuration analysis, e.g., as described below.

In some demonstrative aspects, the SSC configuration analysis may be configured to set a configuration to execute the kernel, e.g., the AGU configuration.

In some demonstrative aspects, the SSC configuration analysis may be performed at a late stage, for example, due to configurations calculated after legalization, the register allocation analysis, and/or the modulo scheduling analysis.

In some demonstrative aspects, the SSC configuration analysis may include a Zero Overhead Loop (ZOL) mechanism in the vector loop. For example, the ZOL mechanism may configure a loop trip count based on an access pattern of the memory references in the loop, for example, to avoid running instructions that check the loop exit condition every iteration.

In some demonstrative aspects, a VMP Compilation Flow may include one or more, e.g., a few, steps, which may be invoked during the compilation flow in a test library (testlib), e.g., a wrapper script for compilation, execution, and/or program testing. For example, these steps may be performed outside of the LLVM Compiler.

In some demonstrative aspects, a PCB Hardware Description Language (PHDL) simulator may be implemented to perform one or more roles of an assembler, encoder, and/or linker.

In some demonstrative aspects, compiler 200 may be configured to provide a technical solution to support robustness, which may enable compilation of a vast selection of loops, with HW limitations. For example, compiler 200 may be configured to support a technical solution, which may not create verification errors.

In some demonstrative aspects, compiler 200 may be configured to provide a technical solution to support programmability, which may provide a user an ability to express code in multiple ways, which may compile correctly to the VMP architecture.

In some demonstrative aspects, compiler 200 may be configured to provide a technical solution to support an improved user-experience, which may allow the user capability to debug and/or profile code. For example, the improved user-experience may provide informative error messages, report tools, and/or a profiler.

some demonstrative aspects, compiler 200 may be configured to provide a technical solution to support improved performance, for example, to optimize a VMP assembly code and/or iterator accesses, which may lead to a faster execution. For example, improved performance may be achieved through high utilization of the compute units and usage of its complex CISC.

Reference is made to FIG. 3, which schematically illustrates a vector processor 300, in accordance with some demonstrative aspects. For example, vector processor 180 (FIG. 1) may be implement one or more elements of vector processor 300, and/or may perform one or more operations and/or functionalities of vector processor 300.

In some demonstrative aspects, vector processor 300 may include a Vector Microcode Processor (VMP).

In some demonstrative aspects, vector processor 300 may include a Wide Vector machine, for example, supporting Very Long Instruction Word (VLIW) architectures, and/or Single Instruction/Multiple Data (SIMD) architectures.

In some demonstrative aspects, vector processor 300 may be configured to provide a technical solution to support high performance for short integral types, which may be common, for example, in computer-vision and/or deep-learning algorithms.

In other aspects, vector processor 300 may include any other type of vector processor, and/or may be configured to support any other additional or alternative functionalities.

In some demonstrative aspects, as shown in FIG. 3, vector processor 300 may include a vector processing block (vector processor) 310, a scalar processor 330, and a Direct Memory Access (DMA) 340, e.g., as described below.

In some demonstrative aspects, as shown in FIG. 3, vector processing block 310 may be configured to process, e.g., efficiently process, image data and/or vector data. For example, the vector processing block 310 may be configured to use vector computation units, for example, to speed up computations.

In some demonstrative aspects, scalar processor 330 may be configured to perform scalar computations. For example, the scalar processor 330 may be used as a “glue logic” for programs including vector computations. For example, some, e.g., even most, of the computation of the programs may be performed by the vector processing block 310. However, several tasks, for example, some essential tasks, e.g., scalar computations, may be performed by the scalar processor 330.

In some demonstrative aspects, the DMA 340 may be configured to interface with one or more memory elements in a chip including vector processor 300.

In some demonstrative aspects, the DMA 340 may be configured to read inputs from a main memory, and/or write outputs to the main memory.

In some demonstrative aspects, the scalar processor 330 and the vector processing block 310 may use respective local memories to process data.

In some demonstrative aspects, as shown in FIG. 3, vector processor 300 may include a fetcher and decoder 350, which may be configured to control the scalar processor 330 and/or the vector processing block 310.

In some demonstrative aspects, operations of the scalar processor 330 and/or the vector processing block 310 may be triggered by instructions stored in a program memory 352.

In some demonstrative aspects, the DMA 340 may be configured to transfer data, for example, in parallel with the execution of the program instructions in memory 352.

In some demonstrative aspects, DMA 340 may be controlled by software, e.g., via configuration registers, for example, rather than instructions, and, accordingly, may be considered as a second “thread” of execution in vector processor 300.

In some demonstrative aspects, the scalar processor 330, the vector processing block 310, and/or the DMA 340 may include one or more data processing units, for example, a set of data processing units, e.g., as described below.

In some demonstrative aspects, the data processing units may include hardware configured to preform computations, e.g., an Arithmetic Logic Unit (ALU).

In one example, a data processing unit may be configured to add numbers, and/or to store the numbers in a memory.

In some demonstrative aspects, the data processing units may be controlled by commands, e.g., encoded in the program memory 352 and/or in configuration registers. For example, the configuration registers may be memory mapped, and may be written by the memory store commands of the scalar processor 330.

In some demonstrative aspects, the scalar processor 330, the vector processing block 310, and/or the DMA 340 may include a state configuration including a set of registers and memories, e.g., as described below.

In some demonstrative aspects, as shown in FIG. 3, vector processor block 310 may include a set of vector memories 312, which may be configured, for example, to store data to be processed by vector processor block 310.

In some demonstrative aspects, as shown in FIG. 3, vector processor block 310 may include a set of vector registers 314, which may be configured, for example, to be used in data processing by vector processor block 310.

In some demonstrative aspects, the scalar processor 330, the vector processing block 310, and/or the DMA 340 may be associated with a set of memory maps.

In some demonstrative aspects, a memory map may include a set of addresses accessible by a data processing unit, which may load and/or store data from/to registers and memories.

In some demonstrative aspects, as shown in FIG. 3, the vector processing block 310 may include a plurality of Address Generation Units (AGUs) 320, which may include addresses accessible to them, e.g., in one or more of memories 312.

In some demonstrative aspects, as shown in FIG. 3, vector processor block 310 may include a plurality of data processing units 316, e.g., as described below.

In some demonstrative aspects, data processing units 316 may be configured to process commands, e.g., including several numbers at a time. In one example, a command may include 8 numbers. In another example, a command may include 4 numbers, 16 numbers, or any other count of numbers.

In some demonstrative aspects, two or more data processing units 316 may be used simultaneously. In one example, data processing units 316 may process and execute a plurality of different command, e.g., 3 different commands, for example, including 8 numbers, at a throughout of a single cycle.

In some demonstrative aspects, data processing units 316 may be asymmetrical. For example, first and second data processing units 316 may support different commands. For example, addition may be performed by a first data processing unit 316, and/or multiplication may be performed by a second data processing unit 316. For example, both operations may be performed by one or more additional other data processing units 316.

In some demonstrative aspects, data processing units 316 may be configured to support arithmetic operations for many combinations of input & output data types.

In some demonstrative aspects, data processing units 316 may be configured to support one or more operations, which may be less common. For example, processing units 316 may support operations working with a Look Up Table (LUT) of vector processor 300, and/or any other operations.

In some demonstrative aspects, data processing units 316 may be configured to support efficient computation of non-linear functions, histograms, and/or random data access, e.g., which may be useful to implement algorithms like image scaling, Hough transforms, and/or any other algorithms.

In some demonstrative aspects, vector memories 312 may include, for example, memory banks having a size of 16K or any other size, which may be accessed at a same cycle.

In one example, a maximal memory access size may be 64 bits. According to this example, a peak throughput may be 256 bits, e.g., 64×4=256. For example, high memory bandwidth may be implemented to utilize computation capabilities of the data processing units 316.

In one example, two data processing units 316 may support 16 8-bit multiply & accumulate operations (MACs) per cycle. According to this example, the two data processing units 316 may not be useful, for example, in case the input numbers are not fetched at this speed, and/or there isn't exactly 256 bits of input, e.g., 16×8×2=256.

In some demonstrative aspects, AGUs 320 may be configured to perform memory access operations, e.g., loading and storing data from/to vector memories 314.

In some demonstrative aspects, AGUs 320 may be configured to compute addresses of input and output data items, for example, to handle I/O to utilize the data processing units 316, e.g., in case sheer bandwidth is not enough.

In some demonstrative aspects, AGUs 320 may be configured to compute the addresses of the input and/or output data items, for example, based on configuration registers written by the scalar processor 330, for example, before a block of vector commands, e.g., a loop, is entered.

For example, AGUs 320 may be configured to write an image base pointer, a width, a height and/or a stride to the configuration registers, for example, in order to iterate over an image.

In some demonstrative aspects, AGUs 320 may be configured to handle addressing, e.g., all addressing, for example, to provide a technical solution in which data processing units 316 may not have the burden of incrementing pointers or counters in a loop, and/or the burden to check for end-of-row conditions, e.g., to zero a counter in the loop.

In some demonstrative aspects, as shown in FIG. 3, AGUs 320 may include 4 AGUs, and, accordingly, four memories 312 may be accessed at a same cycle. In other aspects, any other count of AGUs 32 may be implemented.

In some demonstrative aspects, AGUs 320 may not be “tied” to memory banks 312. For example, an AGU 320, e.g., each AGU 320, may access a memory bank 312, e.g., every memory bank 312, for example, as long as two or more AGUs 320 do not try to access the same memory bank 312 at the same cycle.

In some demonstrative aspects, vector registers 314 may be configured to support communication between the data processing units 316 and AGUs 320.

In one example, a total number of vector registers 314 may be 28, which may be divided into several subsets, e.g., based on their function. For example, a first subset of vector registers 314 may be used for inputs/outputs, e.g., of all data processing units 316 and/or AGUs 320; and/or a second subset of vector registers 314 may not be used for outputs of some operations, e.g., most operations, and may be used for one or more other operations, e.g., to store loop-invariant inputs.

In some demonstrative aspects, a data processing unit 316, e.g., each data processing unit 316, may have one or more registers to host an output of a last executed operation, e.g., which may be fed as inputs to other data processing units 316. For example, these registers may “bypass” the vector registers 314, and may work faster than writing these outputs to first set of vector registers 314.

In some demonstrative aspects, fetcher and decoder 350 may be configured to support low-overhead vector loops, e.g., very low overhead vector loops (also referred to as “zero-overhead vector loops”), for example, where there may be no need to check a termination (exit) condition of a vector loop during an execution of the vector loop.

For example, a termination (exit) condition may be signaled by an AGU 320, for example, when the AGU 320 finishes iterating over a configured memory region.

For example, fetcher and decoder 350 may quit the loop, for example, when the AGU 320 signals the termination condition.

For example, the scalar processor 330 may be utilized to configure the loop parameters, e.g., first & last instructions and/or the exit condition.

In one example, vector loops may be utilized, for example, together with high memory bandwidth and/or cheap addressing, for example, to solve a control and data flow problem, for example, to provide a technical solution to allow the data processing units 316 to process data, e.g., without substantially additional overhead.

In some demonstrative aspects, scalar processor 330 may be configured to provide one or more functionalities, which may be complementary to those of the vector processing block 310. For example, a large portion, e.g., most, of the work in a vector program may be performed by the data processing units 316. For example, the scalar processor 330 may be utilized, for example, for “gluing” together the various blocks of vector code of the vector program.

In some demonstrative aspects, scalar processor 330 may be implemented separately from vector processing block 310. In other aspects, scalar processor 330 may be configured to share one or more components and/or functionalities with vector processing block 310.

In some demonstrative aspects, scalar processor 330 may be configured to perform operations, which may not be suitable for execution on vector processing block 310.

For example, scalar processor 330 may be utilized to execute 32 bit C programs. For example, scalar processor 330 may be configured to support 1, 2, and/or 4 byte data types of C code, and/or some or all arithmetic operators of C code.

For example, scalar processor 330 may be configured to provide a technical solution to perform operations that cannot be executed on vector processing block 310, for example, without using a full-blown CPU.

In some demonstrative aspects, scalar processor 330 may include a scalar data memory 332, e.g., having a size of 16K or any other size, which may be configured to store data, e.g., variables used by the scalar parts of a program.

For example, scalar processor 330 may store local and/or global variables declared by portable C code, which may be allocated to scalar data memory by a compiler, e.g., compiler 200 (FIG. 2).

In some demonstrative aspects, as shown in FIG. 3, scalar processor 330 may include, or may be associated with, a set of vector registers 334, which may be used in data processing performed by the scalar processor 330.

In some demonstrative aspects, scalar processor 330 may be associated with a scalar memory map, which may support scalar processor 330 in accessing substantially all states of vector processor 300. For example, the scalar processor 330 may configure the vector units and/or the DMA channels via the scalar memory map.

In some demonstrative aspects, scalar processor 330 may not be allowed to access one or more block control registers, which may be used by external processors to run and debug vector programs.

In some demonstrative aspects, DMA 340 may be configured to communicate with one or more other components of a chip implementing the vector processor 300, for example, via main memory. For example, DMA 340 may be configured to transfer blocks of data, e.g., large, contiguous, blocks of data, for example, to support the scalar processor 330 and/or the vector processing block, which may manipulate data stored in the local memories. For example, a vector program may be able to read data from the main chip memory using DMA 340.

In some demonstrative aspects, DMA 340 may be configured to communicate with other elements of the chip, for example, via a plurality of DMA channels, e.g., 8 DMA channels or any other count of DMA channels. For example, a DMA channel, e.g., each DMA channel, may be capable of transferring a rectangular patch from the local memories to the main chip memory, or vice versa. In other aspects, the DMA channel may transfer any other type of data block between the local memories and the main chip memory.

In some demonstrative aspects, a rectangular patch may be defined by a base pointer, a width, a height, and astride.

For example, at peak throughput, 8 bytes per cycle may be transferred, however, there may be overheads for each patch and/or for each row in a patch.

In some demonstrative aspects, DMA 340 may be configured to transfer data, for example, in parallel with computations, e.g., via the plurality of DMA channels, for example, as long as executed commands do not access a local memory involved in the transfer.

In one example, as all channels may access the same memory bus, using several channels to implement a transfer may not save I/O cycles, e.g., compared to the case when a single channel is used. However, the plurality of DMA channels may be utilized to schedule several transfers and execute them in parallel with computations. This may be advantageous, for example, compared to a single channel, which may not allow scheduling a second transfer before completion of the first transfer.

In some demonstrative aspects, DMA 340 may be associated with a memory map, which may support the DMA channels in accessing vector memories and/or the scalar data. For example, access to the vector memories may be performed in parallel with computations. For example, access to the scalar data may usually not be allowed in parallel, e.g., as the scalar processor 330 may be involved in almost any sensible program, and may likely access it's local variables while the transfer is performed, which may lead to a memory contention with the active DMA channel.

In some demonstrative aspects, DMA 340 may be configured to provide a technical solution to support parallelization of I/O and computations. For example, a program performing computations may not have to wait for I/O, for example, in case these computations may run fast by vector processing block 310.

In some demonstrative aspects, an external processor, e.g., a CPU, may be configured to initiate execution of a program on vector processor 300. For example, vector processor 300 may remain idle, e.g., as long as program execution is not initiated.

In some demonstrative aspects, the external processor may be configured to debug the program, e.g., execute a single step at a time, halt when the program reaches breakpoints, and/or inspect contents of registers and memories storing the program variables.

In some demonstrative aspects, an external memory map may be implemented to support the external processor in controlling the vector processor 300 and/or debugging the program, for example, by writing to control registers of the vector processor 300.

In some demonstrative aspects, the external memory map may be implemented by a superset of the scalar memory map. For example, this implementation may make all registers and memories defined by the architecture of the vector processor 300 accessible to a debugger back-end running on the external processor.

In some demonstrative aspects, the vector processor 300 may raise an interrupt signal, for example, when the vector processor 300 terminates a program.

In some demonstrative aspects, the interrupt signal may be used, for example to implement a driver to maintain a queue of programs scheduled for execution by the vector processor 300, and/or to launch a new program, e.g., by the external processor, for example, upon the completion of a previously executed program.

Referring back to FIG. 1, in some demonstrative aspects, compiler 160 may be configured to generate the target code 115 based on one or more loops, which may be based, for example, on source code 112, e.g., as described below.

In some demonstrative aspects, the one or more loops may be nested in a loop nest, e.g., as described below.

In some demonstrative aspects, a loop nest may include at least an outer loop and an inner loop, e.g., as described below.

In some demonstrative aspects, the loop nest may include an outer loop, e.g., a most outer loop, an inner loop, e.g., a most inner loop, and one or more nested loops (also referred to as “intermediate nested loops” or “intermediate loops”), which may be nested between the outer loop and the inner loop, e.g., as described below.

In some demonstrative aspects, the loop nest may include a plurality of loops nested in a plurality of nest levels, e.g., as described below.

In one example, the plurality of loops may include a first loop, e.g., an outer loop, for example, in a first nest level, and a second loop, e.g., an inner loop, for example, in a second nest level.

In one example, the plurality of loops may include one or more intermediate loops, for example, in one or more intermediate nest levels, e.g., between the first nest level and the second nest level.

In one example, the plurality of loops may include three loops in three nest levels. For example, the three loops may include a first loop, e.g., an outermost loop, at a first nest level; a second loop, e.g., an intermediate loop, at a second nest level; and a third loop, e.g., an innermost loop, at a third nest level. For example, the second loop may be nested in the first loop, and the third loop may be nested in the second loop.

In some demonstrative aspects, the one or more loops, which may be based, for example, on source code 112 may include, for example, a plurality of memory access operations.

In some demonstrative aspects, the memory access operations may include load operations and/or store operations. In other aspects, the memory access operations may include any other suitable type of memory access operations.

In some demonstrative aspects, compiler 160 may configure one or more AGUs to execute the memory access operations, e.g., as described below.

In some demonstrative aspects, for example, in some use cases, implementations, and/or scenarios, the memory access operations may require a certain number of AGUs, for example, while an available number of AGUs of a target processor, e.g., a vector processor, may be limited.

In one example, the loops may include code, e.g., code of OpenCL programs and/or any other code, which may include many load operations and/or store operations, while the vector processor may only have a relatively low number of available AGUs.

In some demonstrative aspects, there may be a need to provide a technical solution to handle a plurality of memory access operations, for example, in situations when the count of memory access operations exceeds the count of available AGUs, e.g., as described below.

In some demonstrative aspects, for example, in some use cases, implementations, and/or scenarios, a plurality of memory access operations may be performed with respect to a same memory pointer and different offsets.

For example, an implementation using a different AGU for each memory access operation having a different offset may result in a relatively high number of required AGUs, for example, to handle the plurality of memory access operations. For example, the count of available AGUs may be limited, e.g., less than the required number of AGUs.

In some demonstrative aspects, for example, compiler 160 may be configured to compile a source code 112 of an executed program to be executed on a target processor, e.g., vector processor 180, including a limited number of AGUs. For example, the vector processor may include four AGUs, or any other count of AGUs.

For example, compiler 160 may identify, for example, based on source code 112, a loop nest including five memory access operations, e.g., as follows:

```
for(int y = 0; y < height − 2; y++) {
  for(int x = 0; x < width; x++) {
    int index = y * width + x;
    out[index] = inp1[index] * inp1[index + width] + inp1[index + 2 *
      width]−inp2[index];
  }
}
```

### Example (4)

For example, as shown by Example 4, the loop nest may include an outer loop (y loop) along a dimension (Y-dimension) based on a variable height, and an inner loop (x loop) along a dimension (X-dimension) based on a variable width.

For example, as shown by Example 4, the loop nest may include a store operation out [index], and a load operation inp2[index], which may require two AGUs.

For example, as shown by Example 4, the loop nest may include three load operations to a same memory pointer, denoted inp1, e.g., with different offsets.

For example, as shown by Example 4, the loop nest may include a first load operation, e.g., inp1[index], to the memory pointer inp1 with a first offset, e.g., index; a second load operation, e.g., inp1[index+width], to the memory pointer inp1 with a second offset, e.g., index+width; and a third load operation, e.g., inp1[index+2*width], to the memory pointer inp1 with a third offset, e.g., index+2*width.

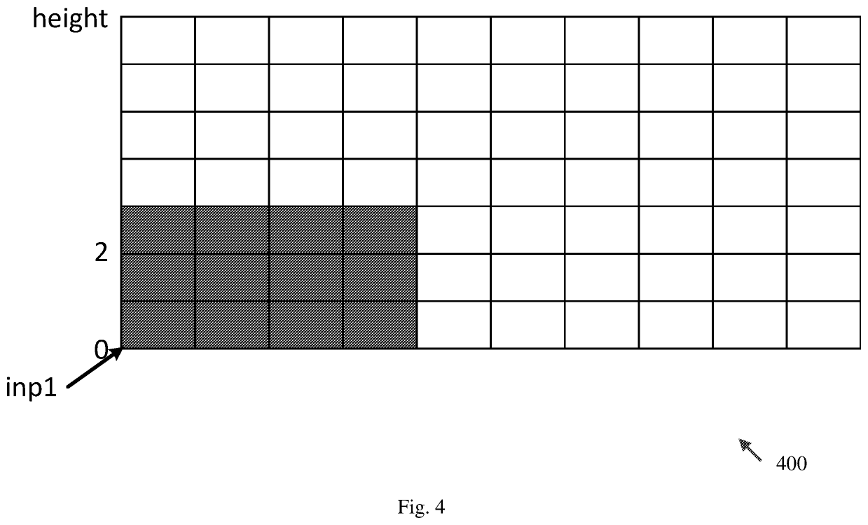

Reference is made to FIG. 4, which schematically illustrates a memory access scheme 400 to load data from a memory with respect to a memory pointer, in accordance with some demonstrative aspects.

In one example, memory access scheme 400 may demonstrate memory accesses with respect to a same memory pointer, e.g., the memory pointer inp1, for example, according to the loop nest of Example 4.

As shown in FIG. 4, the three load operations of Example 4, e.g., inp1[index], inp1[index+width], and inp1[index+2*width], may load data with different offsets, e.g., the offsets index, index+width, and index+2*width, respectively.

As shown in FIG. 4, the three load operations of Example 4 may load the data with the different offsets with respect to the same memory pointer inp1, for example, in the same Y-dimension, for example, with a same difference in the Y-dimension, e.g., with the offsets of 0, 1 and 2 (*width).

For example, an implementation requiring the use of a different AGU for each memory access with a different offset may require a total 5 AGUs to handle the memory access operations of Example 4. For example, a first AGU may be used to handle the store operation out [index], a second AGU may be used to handle the load operation inp2[index], and three additional AGUs may be used to handle the three respective load operations with respect to the memory pointer inp1, e.g., the operations inp1[index], inp1[index+width], and inp1[index+2*width]. According to this example, a target processor may not be able to handle the memory access operations of Example 4, for example, if a count of available AGUs of the target processor is less than 5.

Referring back to FIG. 1, in some demonstrative aspects, compiler 160 may be configured to generate the target code 115, which may be configured, for example, to utilize AGUs of a target processor, e.g., the vector processor 180, for example, according to an AGU configuration scheme, e.g., as described below.

In some demonstrative aspects, the AGU configuration scheme may be configured to provide a technical solution to support configuring a same AGU, for example, to perform a plurality of memory access operations to a same memory pointer, for example, with different offsets, e.g., as described below.

In some demonstrative aspects, the AGU configuration scheme may be configured to provide a technical solution to support implementation of multiple data accesses, for example, using a reduced number of AGUs, for example, in zero-overhead-loops and/or any other type of loops, e.g., as described below.

In some demonstrative aspects, the AGU configuration scheme may be configured to use at least one extra dimension of an AGU, for example, to handle a plurality of memory access operations, e.g., as described below.

In some demonstrative aspects, the AGU configuration scheme may be configured to use a time-shift scheme, for example, to handle a plurality of memory access operations, e.g., as described below.

In some demonstrative aspects, the time-shift scheme may be configured to provide a technical solution to save a history of loads, for example, to handle the plurality of memory access operations, e.g., as described below.

In some demonstrative aspects, the AGU configuration scheme may be configured to utilize the extra AGU dimension and/or the time-shift scheme, for example, to provide a technical solution to support hopping over different memory-access operations, e.g., load and/or store operations, e.g., as described below.

In some demonstrative aspects, the AGU configuration scheme may be configured to interchange between two loop dimensions, e.g., if determined to be necessary, for example, when using the time-shift scheme, e.g., as described below.

In some demonstrative aspects, the AGU configuration scheme may be configured to provide a technical solution to support a configuration, e.g., even any configuration, of memory access operations to a same memory pointer having different offsets, e.g., as described below.

In some demonstrative aspects, the AGU configuration scheme may be configured to provide a technical solution to support a configuration, e.g., even any configuration, of load and/or store operations, for example, where the offsets of the memory access operations to the same memory pointer may change in up to 2 dimensions, e.g., as described below.

In other aspects, the AGU configuration scheme may be configured to support a configuration of memory access operations with offset changes in more than 2 dimensions, e.g., in case this is supported by the AGU.

In some demonstrative aspects, complier 160 may be configured to identify a plurality of memory-access operations in a loop, for example, based on a source code 112 to be compiled into a target code 115 to be executed by a target processor 180, e.g., as described below.

In some demonstrative aspects, compiler 160 may be configured to generate the target code 115 configured, for example, for execution by a target vector processor, for example, a vector processor 180, e.g., as described below.

In some demonstrative aspects, compiler 160 may be configured to generate the target code 115 configured, for example, for execution by a Very Long Instruction Word (VLIW) Single Instruction/Multiple Data (SIMD) target processor, e.g., processor 180.

In other aspects, compiler 160 may be configured to generate the target code 115 configured, for example, for execution by any other suitable type of processor.

In some demonstrative aspects, compiler 160 may be configured to generate the target code 115, for example, based on the source code 112 including Open Computing Language (OpenCL) code.

In other aspects, compiler 160 may be configured to generate the target code 115, for example, based on the source code 112 including any other suitable type of code.

In some demonstrative aspects, compiler 160 may be configured to compile the source code 112 into the target code 115, for example, according to a Low Level Virtual Machine (LLVM) based (LLVM-based) compilation scheme.

In other aspects, compiler 160 may be configured to compile the source code 112 into the target code 115 according to any other suitable compilation scheme.

In some demonstrative aspects, compiler 160 may be configured to identify the plurality of memory-access operations in the loop in source code 112, e.g., in case the loop is included in source code 112.

In some demonstrative aspects, compiler 160 may be configured to identify the plurality of memory-access operations in the loop in code, e.g., middle-end code or any other code, which may be compiled from the source code 112.

In some demonstrative aspects, the plurality of memory-access operations may include a plurality of load operations, e.g., as described below. In other aspects, the plurality of memory-access operations may include any other type of memory-access operations.

In some demonstrative aspects, the plurality of memory-access operations may include at least a first memory-access operation and a second memory-access operation to a same memory pointer, e.g., as described below.

In some demonstrative aspects, the first memory-access operation may have a first offset, e.g., as described below.

In some demonstrative aspects, the second memory-access operation may have a second offset, for example, different from the first offset, e.g., as described below.

In some demonstrative aspects, compiler 160 may be configured to configure AGU configuration code to configure the plurality of memory-access operations by a same AGU, e.g., as described below.

In some demonstrative aspects, compiler 160 may be configured to generate the target code 115, for example, based on compilation of the source code 112, e.g., as described below.

In some demonstrative aspects, compiler 160 may be configured to generate the target code 115 to be based, for example, on the AGU configuration code, e.g., as described below.

In some demonstrative aspects, the target code 115 may include some or all of the AGU configuration code.

In other aspects, the target code 115 may be generated, for example, based on further processing and/or compilation of the AGU configuration code.

In some demonstrative aspects, compiler 160 may be configured to configure the AGU configuration code to configure the plurality of memory-access operations, for example, based on a dimension of the loop, e.g., as described below.

In some demonstrative aspects, the first offset may include a first integer multiple of the dimension of the loop, e.g., as described below.

In some demonstrative aspects, the second offset may include a second integer multiple of the dimension of the loop, e.g., as described below.

In some demonstrative aspects, compiler 160 may be configured to configure the AGU configuration code to configure the plurality of memory-access operations, for example, based on a difference between the first offset and the second offset, e.g., as described below.

In some demonstrative aspects, compiler 160 may be configured to configure the AGU configuration code to configure the plurality of memory-access operations based on the difference between the first offset and the second offset, for example, based on a determination that the difference between the first offset and the second offset is independent of a dimension of the loop, e.g., as described below.

In some demonstrative aspects, compiler 160 may be configured to configure the AGU configuration code to configure a first dimension of the AGU, for example, based on the dimension of the loop, e.g., as described below.

In some demonstrative aspects, compiler 160 may be configured to configure the AGU configuration code to configure the first dimension of the AGU based on the dimension of the loop, for example, based on a determination that the difference between the first offset and the second offset is based on an integer multiple of the dimension of the loop, and is that the difference between the first offset and the second offset based on a dimension-independent value, which may be independent of the dimension of the loop, e.g., as described below.

In some demonstrative aspects, compiler 160 may be configured to configure the AGU configuration code to configure a second dimension of the AGU, for example, based on the independent value, e.g., as described below.

In some demonstrative aspects, the plurality of memory-access operations may include a third memory-access operation to the same memory pointer, e.g., as described below.

In some demonstrative aspects, the third memory-access operation may have a third offset different from the first offset and the second offset, e.g., as described below.

In some demonstrative aspects, compiler 160 may be configured to configure the AGU configuration code to configure the plurality of memory-access operations by the same AGU, for example, based on the third offset, e.g., as described below.

In some demonstrative aspects, the loop may include a first loop, e.g., as described below.

In some demonstrative aspects, the first loop may be nested in a second loop, e.g., as described below.

In some demonstrative aspects, compiler 160 may be configured to configure the AGU configuration code, for example, based on the second loop, e.g., as described below.

In some demonstrative aspects, compiler 160 may be configured to configure the AGU configuration code, for example, to include a first dimension code to configure a first dimension of the AGU, for example, based on the first loop, e.g., as described below.

In some demonstrative aspects, compiler 160 may be configured to configure the AGU configuration code, for example, to include a second dimension code to configure a second dimension of the AGU, for example, based on the plurality of memory-access operations, e.g., as described below.

In some demonstrative aspects, compiler 160 may be configured to configure the AGU configuration code, for example, to include a third dimension code to configure a third dimension of the AGU, for example, based on the second loop, e.g., as described below.

In some demonstrative aspects, compiler 160 may be configured to configure the AGU configuration code, for example, to include a loop-interchange instruction, which may be configured to instruct a loop interchange between a dimension of the AGU corresponding to the first loop and a dimension of the AGU corresponding to the second loop, e.g., as described below.

In some demonstrative aspects, compiler 160 may be configured to configure the AGU configuration code to include a loop-interchange instruction, for example, based on a determination that the difference between the first offset and the second offset is based on a dimension of the second loop, e.g., as described below.

In some demonstrative aspects, the AGU configuration code may include code to configure the same AGU, for example, according to an extra-dimension configuration scheme, e.g., as described below.

In some demonstrative aspects, compiler 160 may be configured to configure the AGU configuration code to include code to configure the same AGU, for example, according to the extra-dimension configuration scheme, e.g., as described below.

In some demonstrative aspects, the extra-dimension configuration scheme may be configured to configure an additional dimension of the AGU, for example, based on the plurality of memory-access operations, e.g., as described below.

In some demonstrative aspects, the AGU configuration code may include, for example, first dimension code to configure a first dimension of the AGU, for example, based on the loop, e.g., as described below.

In some demonstrative aspects, the AGU configuration code may include second dimension code to configure an additional dimension of the AGU, e.g., a second dimension of the AGU, for example, based on the plurality of memory-access operations, e.g., as described below.

For example, the first dimension code may configure a plurality of first dimensions of the AGU, e.g., including an x-dimension and/or a y-dimension, for example, based on the loop; and/or the second dimension code may configure a second, e.g., additional, dimension of the AGU, e.g., a z-dimension, for example, based on the plurality of memory-access operations, e.g., as described below.

In some demonstrative aspects, compiler 160 may be configured to configure the first dimension code to set a count parameter of the first dimension of the AGU, for example, based on a count parameter of the loop, e.g., as described below.

In some demonstrative aspects, compiler 160 may be configured to configure the first dimension code to set a step parameter of the first dimension of the AGU, for example, based on a step parameter of the loop, e.g., as described below.

In some demonstrative aspects, compiler 160 may be configured to configure the second dimension code to set a count parameter of the second dimension of the AGU, for example, based on a total count of memory-access operations in the plurality of memory-access operations, e.g., as described below.

In some demonstrative aspects, compiler 160 may be configured to configure the second dimension code to set a step parameter of the second dimension of the AGU, for example, based on the difference between the first offset and the second offset, e.g., as described below.

In some demonstrative aspects, compiler 160 may be configured to generate loop code, for example, based on the loop, e.g., as described below.

In some demonstrative aspects, compiler 160 may be configured to generate target code 115, for example, based on the loop code, e.g., as described below.

In some demonstrative aspects, the loop code may include a plurality of memory-access instructions to be executed, for example, by the same AGU, e.g., as described below.

In some demonstrative aspects, the plurality of memory-access instructions may correspond to the plurality of memory-access operations, respectively, e.g., as described below.

In some demonstrative aspects, the plurality of memory-access operations may include a third memory-access operation to the same memory pointer, e.g., as described below.

In some demonstrative aspects, the third memory-access operation may have a third offset, for example, different from the first offset and the second offset, e.g., as described below.

In some demonstrative aspects, compiler 160 may be configured to generate the loop code including first, second, and third memory-access instructions to be executed by the same AGU, for example, based on the first, second and third memory-access instructions, respectively, e.g., as described below.

In some demonstrative aspects, the target code 115 may be based, for example, on the loop code including the first, second, and third memory-access instructions to be executed by the same AGU, e.g., as described below.

In some demonstrative aspects, compiler 160 may be configured to identify, for example, that a first difference between the first offset and the second offset is equal to a second difference between the second offset and the third offset, e.g., as described below.

In some demonstrative aspects, compiler 160 may be configured to configure the second dimension of the AGU, for example, based on the second difference, for example, based on a determination that the first difference is equal to the second difference, e.g., as described below.

In some demonstrative aspects, the loop may include a first loop, e.g., an inner loop, e.g., as described below.

In some demonstrative aspects, the first loop may be nested in a second loop, e.g., an outer loop, e.g., as described below.

In some demonstrative aspects, compiler 160 may be configured to configure the AGU configuration code to include third dimension code to configure a third dimension of the AGU, for example, based on the second loop, e.g., as described below.

In some demonstrative aspects, compiler 160 may be configured to selectively configure the AGU configuration code based on the plurality of memory-access operations, for example, based on one or more conditions, e.g., as described below.

In some demonstrative aspects, compiler 160 may be configured to configure the AGU configuration code based on the plurality of memory-access operations, for example, based on a determination that a count of dimensions of the first loop is less than a count of dimensions supported by the same AGU, e.g., as described below.

In some demonstrative aspects, compiler 160 may be configured to configure the AGU configuration code based on the plurality of memory-access operations, for example, based on a determination that the plurality of memory-access operations have no bounds and no pass-throughs, e.g., as described below.

In some demonstrative aspects, compiler 160 may be configured to configure the AGU configuration code based on the plurality of memory-access operations, for example, based on a determination that differences between consecutive offsets of the plurality of memory-access operations are the same, e.g., as described below.

In some demonstrative aspects, compiler 160 may be configured to configure the AGU configuration code based on the plurality of memory-access operations, for example, based on a determination that the count of dimensions of the first loop is less than a count of dimensions supported by the same AGU, that the plurality of memory-access operations have no bounds and no pass-throughs, an/or that the differences between consecutive offsets of the plurality of memory-access operations are the same, e.g., as described below.

In other aspects, compiler 160 may be configured to configure the AGU configuration code based on the plurality of memory-access operations, for example, based on any other additional and/or alternative conditions and/or criteria.

In some demonstrative aspects, the AGU configuration code may include code to configure the same AGU, for example, according to a time-shift scheme, e.g., as described below.

In some demonstrative aspects, compiler 160 may be configured to configure the AGU configuration code to include code to configure the same AGU, for example, according to the time-shift scheme, e.g., as described below.

In some demonstrative aspects, the time-shift scheme may be configured to implement the plurality of memory-access operations, for example, as a plurality of time-shifted memory-access operations of the same AGU, for example, during a plurality of respective loop iterations, e.g., as described below.

In some demonstrative aspects, compiler 160 may be configured to configure the AGU configuration code to include a loop-interchange instruction for a dimension of the AGU corresponding to the loop, e.g., as described below.

In some demonstrative aspects, the loop-interchange instruction may be configured to instruct a loop interchange, for example, between the dimension of the AGU corresponding to the loop and another dimension of the AGU corresponding to an outer loop, e.g., as described below.

In some demonstrative aspects, compiler 160 may be configured to configure the AGU configuration code to include the loop-interchange instruction for the dimension of the AGU corresponding to the loop, for example, based on a determination that a difference between the first offset and the second offset is based, for example, on a dimension of an other loop, for example, the outer loop, which includes the loop including the plurality of memory-access operations, e.g., as described below,

In some demonstrative aspects, compiler 160 may be configured to configure the loop-interchange instruction to instruct a loop interchange between the dimension of the AGU corresponding to the loop and another dimension of the AGU corresponding to the other loop, for example, the outer loop, e.g., as described below.

In some demonstrative aspects, compiler 160 may be configured to selectively utilize the loop-interchange instruction based on one or more conditions, e.g., as described below.

In some demonstrative aspects, compiler 160 may be configured to selectively utilize the loop-interchange instruction, for example, based on a determination that the plurality of memory-access operations are not in the inner loop, e.g., as described below.

In some demonstrative aspects, compiler 160 may be configured to selectively utilize the loop-interchange instruction, for example, based on a determination whether or not differences between offsets of the plurality of memory-access operations are based on a dimension of an inner loop, e.g., as described below.

In some demonstrative aspects, compiler 160 may be configured to utilize the loop-interchange instruction, for example, based on a determination that the differences between the offsets of the plurality of memory-access operations are based on a dimension of an other loop, e.g., an outer loop.

In some demonstrative aspects, compiler 160 may be configured to configure the AGU configuration code, e.g., according to the time-shift scheme, for example, to set a same count parameter for all AGUs to perform memory-access operations during the loop, e.g., as described below.

In some demonstrative aspects, the same count parameter may be based, for example, on a count parameter of the loop, a maximal offset of the plurality of memory-access operations, and/or a minimal offset of the plurality of memory-access operations, e.g., as described below.

In other aspects, the same count parameter may be configured based on any other additional or alternative parameter and/or criteria.

In some demonstrative aspects, compiler 160 may be configured to configure the AGU configuration code, e.g., according to the time-shift scheme, for example, to set the same count parameter, denoted Count, e.g., as follows:

$$Count = Align Up To ( ( MaxXOffset - MinXOffset ) + Count ( Loop ) , VF ) / VF$$

wherein MaxXOffset denotes the maximal offset of the plurality of memory access operations,
wherein MinXOffst denotes the minimal offset of the plurality of memory access operations,
wherein VF denotes a vectorization factor,
wherein Count (Loop) denotes the count parameter of the loop, and
wherein the operation AlignUpTo(a,b) may align-up a to an integer multiple of b.

In some demonstrative aspects, compiler 160 may be configured to generate loop code based on the loop, and pre-header code to be executed before a header of the loop code, e.g., as described below.

In some demonstrative aspects, compiler 160 may be configured to generate the pre-header code, for example, when generating the AGU configuration code according to the time-shift scheme, e.g., as described below.

For example, the pre-header code may be generated for all AGU-based implementations of any loops in the loop, for example, to set AGU parameters, for example, when generating the AGU configuration code according to the time-shift scheme, e.g., as described below.

In some demonstrative aspects, the target code 115 may be based on the loop code and/or the pre-header code, e.g., as described below.

In some demonstrative aspects, the pre-header code may include a plurality of AGU load instructions to be executed by the same AGU, e.g., as described below.

In some demonstrative aspects, a count of the AGU load instructions in the plurality of AGU load instructions may be based, for example, on a count of memory-access operations in the plurality of memory-access operations, e.g., as described below.

In some demonstrative aspects, the count of the AGU load instructions in the plurality of AGU load instructions may be, for example, equal to the count of memory-access operations in the plurality of memory-access operations, e.g., as described below.

In other aspects, any other suitable count of AGU load instructions may be utilized.

In some demonstrative aspects, compiler 160 may be configured e loop code to include a plurality of store instructions, which may be configured to store results of a respective plurality of AGU load iterations by the same AGU, e.g., as described below.

In some demonstrative aspects, a count of the plurality of store instructions may be based, for example, on the count of memory-access operations in the plurality of memory-access operations, e.g., as described below.

In some demonstrative aspects, the count of the plurality of store instructions may be, for example, equal to the count of memory-access operations in the plurality of memory-access operations, e.g., as described below.

In other aspects, any other suitable count of store instructions may be utilized.

In some demonstrative aspects, compiler 160 may be configured to generate the plurality of store instructions, which may be configured to cause the target processor 180 to store a plurality of load results of the plurality of AGU load instructions in the pre-header code, for example, at a first-in-order iteration of the plurality of AGU load iterations, e.g., as described below.

In some demonstrative aspects, compiler 160 may be configured to selectively configure the AGU configuration code to include code to configure the same AGU according to the time-shift scheme, for example, based on one or more conditions, e.g., as described below.

In some demonstrative aspects, compiler 160 may be configured to configure the AGU configuration code to include code to configure the same AGU according to the time-shift scheme, for example, based on a determination that the plurality of memory-access operations includes only load operations, e.g., as described below.

In some demonstrative aspects, compiler 160 may be configured to configure the AGU configuration code to include code to configure the same AGU according to the time-shift scheme, for example, based on a determination that differences between consecutive offsets of the plurality of memory-access operations are independent of the dimension of the loop, e.g., as described below.

In some demonstrative aspects, compiler 160 may be configured to configure the AGU configuration code to include code to configure the same AGU according to the time-shift scheme, for example, based on a determination that the plurality of memory-access operations have no bounds and/or no pass-throughs, e.g., as described below.

In some demonstrative aspects, compiler 160 may be configured to configure the AGU configuration code to include code to configure the same AGU according to the time-shift scheme, for example, based on a determination that the plurality of memory-access operations are not masked, e.g., as described below.

In some demonstrative aspects, compiler 160 may be configured to configure the AGU configuration code to include code to configure the same AGU according to the time-shift scheme, for example, based on a determination that the loop does not include any side effects, e.g., as described below.

In some demonstrative aspects, compiler 160 may be configured to configure the AGU configuration code to include code to configure the same AGU according to the time-shift scheme, for example, based on a determination that the plurality of memory-access operations include only load operations, that the differences between consecutive offsets of the plurality of memory-access operations are independent of the dimension of the loop, that the plurality of memory-access operations have no bounds and no pass-throughs, that the plurality of memory-access operations are not masked, and/or that the loop does not include any side effects, e.g., as described below.

In other aspects, compiler 160 may be configured to configure the AGU configuration code to include code to configure the same AGU according to the time-shift scheme, for example, based on any other additional and/or alternative condition and/or criteria.

In some demonstrative aspects, compiler 160 may be configured to compile a loop nest based on source code 112, e.g., the loop of Example 4, for example, according to an AGU configuration scheme, e.g., as described below.

In some demonstrative aspects, compiler 160 may be configured to generate AGU configuration code of the loop, e.g., the loop of Example 4, for example, to provide a technical solution to support the memory access operations of Example 4, for example, with a reduced number of AGUs, e.g., as described below.

In some demonstrative aspects, compiler 160 may be configured to compile the source code 112, for example, according to an extra-dimension configuration scheme, e.g., as described below.

In some demonstrative aspects, compiler 160 may be configured to determine whether to compile the source code 112 according to the extra-dimension configuration scheme, for example, based on one or more predefined conditions, e.g., as described below.

In some demonstrative aspects, the one or more predefined conditions may include a first condition, which may be based, for example, on a count of dimensions of the loop nest.

In some demonstrative aspects, compiler 160 may be configured to determine whether the loop nest based on the source code 112 may be compiled according to the extra-dimension configuration scheme, for example, based on a condition relating to a count of dimensions of the loop nest, and a count of supported dimensions, which may be supported by an AGU, e.g., each AGU, of the target processor, e.g., vector processor, to execute the target code 115, e.g., as described below.

In some demonstrative aspects, compiler 160 may be configured to determine that the loop nest based on the source code 112 may be compiled according to the extra-dimension configuration scheme, for example, based on a determination that the count of dimensions of the loop nest is less than the count of supported dimensions of the target processor 180 to execute the target code 115, e.g., as described below.

In one example, an AGU of a processor, e.g., a vector processor, may support four dimensions. According to this example, compiler 160 may be configured to determine whether the loop nest based on the source code 112 may be compiled according to the extra-dimension configuration scheme, for example, based on a determination of whether or not the count of dimensions of the loop nest is less than 4, e.g., #LoopDimensions<=3.

In some demonstrative aspects, the one or more predefined conditions may include a second condition, which may be based, for example, on differences between offsets of the memory access operations to a same memory pointer, e.g., as described below.

In some demonstrative aspects, compiler 160 may be configured to determine whether the loop nest based on the source code 112 may be compiled according to the extra-dimension configuration scheme, for example, based on a determination of whether or not all differences between offsets of every two consecutive memory access operations to the same pointer are the same, e.g., as described below.

In one example, two consecutive memory access operations may include memory access operations, which are consecutive in terms of the offsets, for example, when the memory access operations are sorted by their offsets.

In some demonstrative aspects, compiler 160 may be configured to determine that the loop nest based on the source code 112 may be compiled according to the extra-dimension configuration scheme, for example, based on a determination that the differences between the offsets of consecutive memory access operations, e.g., every two consecutive memory access operations, are the same.

In some demonstrative aspects, the one or more predefined conditions may include a third condition, which may be based, for example, on bounds of the memory access operations to the same memory pointer.

In some demonstrative aspects, compiler 160 may be configured to determine that the loop nest based on the source code 112 may be compiled according to the extra-dimension configuration scheme, for example, based on a determination that any bound conditions (bounds), e.g., with any pass-through, are the same for all memory access operations to the same memory pointer, e.g., as described below.

In some demonstrative aspects, some or all of the conditions may be implemented to determine whether or not the extra-dimension configuration scheme may be applied to the loop nest, and/or any other additional conditions, rules and/or criteria may be implemented to determine the extra-dimension configuration scheme may be applied to the loop nest.

In some demonstrative aspects, compiler 160 may identify the three load operations to the same memory pointer inp1 with the different offsets, e.g., the load operations inp1[index], inp1[index+width], and inp1[index+2*width], for example, based on the loop nest of Example 4.

In some demonstrative aspects, compiler 160 may be configured to verify that the three load operations to the same memory pointer have the same strides, e.g., in all loops of the loop nest of Example 4. For example, compiler 160 may verify that all three load operations inp1[index], inp1[index+width], and inp1[index+2*width] have the same strides in the inner loop X, e.g., Step (X-Loop)=VectorSize, and the outer loop Y, e.g., Step (Y-Loop)=width.

In some demonstrative aspects, compiler 160 may be configured to identify that the offsets of the three load operations inp1[index], inp1[index+width], and inp1[index+2*width] are different in the Y-dimension. For example, compiler 160 may be configured to identify that the load operation inp1[index] has an offset of 0 (*width) in the Y-dimension, the load operation inp1[index+width] has an offset of 1 (*width) in the Y-dimension, and the load operation inp1[index+2*width] has an offset of 2 (*width) in the Y-dimension.

In some demonstrative aspects, compiler 160 may be configured to select to utilize a non-interchanged loop scheme to compile the loop nest of Example 4, for example, in which the outer loop Y remains the outermost loop, and the inner loop X remain the innermost loop, e.g., as described below.

In some demonstrative aspects, compiler 160 may be configured to select to utilize the non-interchanged loop scheme, for example, based on a selection to compile the loop nest of Example 4 according to the extra-dimension configuration scheme, e.g., as described below.

In some demonstrative aspects, compiler 160 may be configured to verify whether the predefined conditions for implementing the extra-dimension configuration scheme are met with respect to the loop nest of Example 4, e.g., as described below.

In some demonstrative aspects, compiler 160 may be configured to verify that the number of dimensions of the loop nest of Example 4 is less than four, e.g., the number of AGU dimensions supported by the AGU.

In some demonstrative aspects, compiler 160 may be configured to verify that the differences between the offsets of the three load operations are the same.

In some demonstrative aspects, compiler 160 may be configured to verify that the plurality of memory-access operations have no bounds and no pass-throughs, e.g., that any bounds of the three load operations are the same.

In some demonstrative aspects, compiler 160 may determine that the predefined conditions are met with respect to the loop nest of Example 4, for example, by determining that the number of dimensions of the loop, e.g., two loops, meets the condition on the number of dimensions, e.g., #loop-dimensions=2<=3.

In some demonstrative aspects, compiler 160 may determine that the predefined conditions are met with respect to the loop nest of Example 4, for example, by determining that the differences between the offsets are all equal to 1 (*width), e.g., differences between the offsets (1−0=2−1=1).

In some demonstrative aspects, compiler 160 may determine that the predefined conditions are met with respect to the loop nest of Example 4, for example, by determining that there are no bounds or pass-throughs in the plurality of memory-access operations of the loop nest.

In some demonstrative aspects, compiler 160 may be configured to compile the source code 112, for example, according to the extra-dimension configuration scheme, for example, based on the determination that all pre-conditions for the extra-dimension configuration scheme are met.

In some demonstrative aspects, compiler 160 may be configured to set AGU configuration code for the AGU, for example, according to the extra-dimension configuration scheme, e.g., as described below.

In some demonstrative aspects, compiler 160 may be configured to set a count parameter of the additional dimension, for example, based on the total count of memory accesses.

For example, compiler 160 may identify that the loop nest of Example 4 includes the three load operations inp1[index], inp1[index+width], and inp1[index+2*width]. Accordingly, compiler 160 may set the count parameter for the additional dimension to three, e.g., Count (Extra-dim)=#AccessesInTheGroup=3.

In some demonstrative aspects, compiler 160 may be configured to set a step parameter of the additional dimension of the AGU, for example, based on the difference between the offsets.

For example, compiler 160 may identify that the difference between consecutive offsets of the three load operations is equal to 1 (*width), e.g., as described above. Accordingly, compiler 160 may set the step parameter of the additional dimension of the AGU be 1*width, e.g., Step(Extra-dim)=DifferenceBetween2ClosestOffsets*Stride=1*width.

In some demonstrative aspects, compiler 160 may be configured to generate AGU configuration code and loop code for the loop nest of Example 4, for example, according to the extra-dimension configuration scheme, e.g., as follows:

```
AGU configuration code:
  agu1 = allocate_agu(“load”);
  set_base(agu1, inp1);
  set_y_minmax(agu1, 0, (height − 2) * width);
  set_y_count_stride(agu1, height − 2, width);
  set_x_minmax(agu1, 0, width);
  VectorizationFactor = 32;
  Xcount = AlignUpTo(width, VectorizationFactor)/VectorizationFactor;
  VectorSize = VectorizationFactor * 1;
  set_x_count_stride(agu1, Xcount, VectorSize);
  set_z_count_stride(agu1, 3, width);
  agu2 = allocate_agu(“load”);
  set_base(agu2, inp2);
  set_y_minmax(agu2, 0, (height − 2) * width);
  set_y_count_stride(agu2, height − 2, width);
  set_x_minmax(agu2, 0, width);
  set_x_count_stride(agu2, Xcount, VectorSize);
  agu_out = allocate_agu(“store”);
  set_base(agu_out, out);
  set_y_minmax(agu_out, 0, (height − 2) * width);
  set_y_count_stride(agu_out, height − 2, width);
  set_x_minmax(agu_out, 0, width);
  set_x_count_stride(agu_out, Xcount, VectorSize);
Loop:
  %val0 = agu1.load( ); agu1.bump( );
  %val1 = agu1.load( ); agu1.bump( );
  %val2 = agu1.load( ); agu1.bump( );
  %val_inp2 = agu2.load( ); agu2.bump( );
  %temp = mul %val0, %val1;
  %temp1 = add %temp, val2;
  %result = sub %temp1, %val_inp2;
  agu_out.store(%result); agu_out.bump( );
  br(Loop);
```

### Example (5)

In some demonstrative aspects, as shown by Example 5, the AGU configuration code for agu1 may include AGU configuration code for an additional dimension, e.g., the dimension z.

In some demonstrative aspects, as shown by Example 5, the additional dimension z may be configured, for example, in addition to the dimension x, which may be configured based on the X-loop, and to the dimension y, which may be configured based on the Y-loop.

In some demonstrative aspects, the AGU configuration code for agu1 may include AGU configuration code, e.g., set_z_count_stride(agu1, 3, width), for example, to set the count parameter for the dimension z to three, e.g., “3”.

In some demonstrative aspects, the AGU configuration code for agu1 may include AGU configuration code, e.g., set_z_count_stride(agu1, 3, width), for example, to set the stride (step) parameter for the dimension z to 1*width, e.g., width.

In some demonstrative aspects, as shown by Example 5, the loop code may include three load instructions to the same pointer, e.g., agu1, which may correspond to the three load operations, e.g., as follows:

$$\begin{matrix}\% val 0 = agu 1. load ( ) ; agu 1. bump ( ) ; \\ \% val 1 = agu 1. load ( ) ; agu 1. bump ( ) ; \\ \% val 2 = agu 1. load ( ) ; agu 1. bump ( ) ;\end{matrix}$$

For example, the instruction % val0=agu1.load( ) agu1.bump( ) may be configured to store in the register % val0 a value loaded by the agu1 in a first iteration over the dimension z, e.g., corresponding to the load operation inp1[index].

For example, the instruction % val1=agu1.load( ) agu1.bump( ) may be configured to store in the register % val1 a value loaded by the agu1 in a second iteration over the dimension z, e.g., corresponding to the load operation inp1[index+width].

For example, the instruction % val2=agu1.load( ) agu1.bump( ) may be configured to store in the register % val2 a value loaded by the agu1 in a third iteration over the dimension z, e.g., corresponding to the load operation inp1[index+2*width].

In some demonstrative aspects, compiler 160 may be configured to compile the source code 112, for example, according to a time-shift scheme, e.g., as described below.

In some demonstrative aspects, compiler 160 may be configured to determine whether to compile the source code 112 according to the time-shift scheme, for example, based on one or more predefined conditions, e.g., as described below.

In some demonstrative aspects, the one or more predefined conditions may include a first condition, which may require that the time-shift scheme may be applied, for example, only with respect to load operations, e.g., not for store operations.

In some demonstrative aspects, the one or more predefined conditions may include a second condition, which may require that a dimension including the load operations to be compiled according to the time-shifted scheme (“the time-shifted dimension”) should be, or may become, a dimension of an innermost loop of the loop nest.

In some demonstrative aspects, for example, the time-shift scheme may include a loop interchange instruction, for example, if possible, for example, in case the time-shifted dimension is not already the dimension of the innermost loop of the loop nest.

In some demonstrative aspects, the one or more predefined conditions may include a third condition, which may be based, for example, on differences between offsets of the memory access operations to the same memory pointer, e.g., as described below.

In some demonstrative aspects, compiler 160 may be configured to determine whether the loop nest based on the source code 112 may be compiled according to the time-shift scheme, for example, based on a determination whether differences between offsets of every two, e.g., consecutive and/or non-consecutive, memory access operations to the same pointer are constant, e.g., are known at compile time, and/or do not change during execution time.

In some demonstrative aspects, compiler 160 may be configured to determine that the loop nest based on the source code 112 may be compiled according to the time-shift scheme, for example, based on a determination that the differences between the offsets of the memory access are constant, e.g., known at compile time.

In some demonstrative aspects, the one or more predefined conditions may include a fourth condition, which may be based, for example, on bounds of the memory access operations to the same pointer.

In some demonstrative aspects, compiler 160 may be configured to determine that the loop nest based on the source code 112 may be compiled according to the time-shift scheme, for example, based on a determination that any bound conditions (bounds), e.g., with any pass-through, may fit for all memory access operations to the same pointer, e.g., as described below.

In some demonstrative aspects, the one or more predefined conditions may include a fifth condition relating to side-effects of the loop nest.

For example, compiler 160 may be configured to determine the time-shift scheme may be applied to the loop nest, for example, based on a determination that the loop nest does not include one or more certain side-effects, e.g., only when the loop nest does not include one or more certain side-effects.

In some demonstrative aspects, the one or more predefined conditions may include a sixth condition relating to masking of the load operations in the loop nest.

For example, compiler 160 may be configured to determine the time-shift scheme may be applied to the loop nest, for example, based on a determination that the load operations in the loop nest are not masked, e.g., only when the load operations in the loop nest are not masked.

In some demonstrative aspects, some or all of the conditions may be implemented to determine whether or not the time-shift scheme may be applied to the loop nest, and/or any other additional conditions, rules and/or criteria may be implemented to determine the time-shift scheme may be applied to the loop nest.

In some demonstrative aspects, compiler 160 may identify the three load operations to the same memory pointer inp1 with the different offsets, e.g., the load operations inp1[index], inp1[index+width], and inp1[index+2*width], for example, based on the loop nest of Example 4.

In some demonstrative aspects, compiler 160 may be configured to verify that the three load operations to the same memory pointer have the same strides in all loops of the loop nest of Example 4. For example, compiler 160 may verify that all three load operations inp1[index], inp1[index+width], and inp1[index+2*width] have the same strides in the inner loop X, e.g., Step (X-Loop)=VectorSize, and the outer loop Y, e.g., Step (Y-Loop)=width.

In some demonstrative aspects, compiler 160 may be configured to identify that the offsets of the three load operations inp1[index], inp1[index+width], and inp1[index+2*width] are different in the Y-dimension. For example, the load operation inp1[index] has an offset of 0 (*width) in the Y-dimension, the load operation inp1[index+width] has an offset of 1 (*width) in the Y-dimension, and the load operation inp1[index+2*width] has an offset of 2 (*width) in the Y-dimension.

In some demonstrative aspects, compiler 160 may be configured to verify whether the predefined conditions for implementing the time-shift scheme are met with respect to the loop nest of Example 4.

In some demonstrative aspects, compiler 160 may be configured to verify that all three memory access operations of Example 4 are load operations.

In some demonstrative aspects, compiler 160 may be configured to verify that the differences between the offsets of the three load operations of Example 4 are constant.

In some demonstrative aspects, compiler 160 may be configured to verify that any bounds of the three load operations of Example 4 are the same.

In some demonstrative aspects, compiler 160 may be configured to verify that the loop nest of Example 4 does not include side effects.

In some demonstrative aspects, compiler 160 may be configured to verify that the three load operations of Example 4 are not masked.

In some demonstrative aspects, compiler 160 may be configured to compile the source code 112, for example, according to the time-shift scheme, for example, based on the determination that all pre-conditions for the time-shift scheme are met.

In some demonstrative aspects, compiler 160 may be configured to determine whether or not a loop interchange is needed and/or possible for the loop nest.

In some demonstrative aspects, compiler 160 may determine that the loop interchange is needed, for example, based on a determination that the time-shift is to be performed on the Y-dimension, which is not originally a dimension of the innermost loop.

In some demonstrative aspects, compiler 160 may determine that the loop interchange is possible, for example, based on a determination that the loop nest includes a perfect loop nest and there are no side-effects in the loop nest.

In some demonstrative aspects, compiler 160 may be configured to set AGU configuration code for the plurality of AGUs of the target processor, e.g., processor 180, for example, to set an AGU configuration, e.g., a vertical time shifts (“ShortColumn”) configuration, which may indicate that the time-shift scheme is to be implemented, e.g., as described below.

In some demonstrative aspects, compiler 160 may be configured to set a same count parameter, denoted Count (Dim), in the time-shifted dimension, e.g., the Y-dimension, for example, for all of the plurality of AGUs, e.g., as described below.

In some demonstrative aspects, compiler 160 may be configured to set the same count parameter for the time-shifted dimension, for example, based on a count parameter of the loop of the time-shifted dimension, e.g., the Y-dimension, a maximal offset of the three load operations to the same memory pointer, and a minimal offset of the three load operations, e.g., as follows:

$$Count ( Ydim ) = ( MaxYOffset - MinYOffset ) + Count ( LoopYDim )$$

wherein, MaxYOffset denotes a maximum offset in the time-shifted dimension, e.g., the Y-dimension, over all the three load operations covered by the AGU, and
wherein MinYOffst denotes a minimum offset in the time-shifted dimension, e.g., the Y-dimension, over all the loads covered by the AGU.

In some demonstrative aspects, compiler 160 may be configured to set a loop-interchange instruction, e.g., set_y_innerloop (AGU), to indicate a loop interchange for the Y-dimension, for example, for all of the AGUs of the target processor 180, e.g., in case the loop interchange is required.

In some demonstrative aspects, compiler 160 may be configured to generate loop code based on the loop, and pre-header code to be executed before a header of the loop code, e.g., as described below.

In some demonstrative aspects, compiler 160 may be configured to configure the loop code, for example, to load only one value inside the loop by the same AGU, which is utilized to implement the plurality of load operations. For example, the loop code may include only one load operation, e.g., as described below.

In some demonstrative aspects, compiler 160 may be configured to generate the pre-header code to load initial values by the same AGU, e.g., prior to execution of the loop. For example, the pre-header code may include a plurality of AGU load instructions to be executed by the same AGU, for example, prior to execution of the loop, e.g., as described below.

In some demonstrative aspects, compiler 160 may be configured to remember and/or to keep, e.g., store in registers, other values from previous AGU load iterations in the loop, e.g., as described below.

In some demonstrative aspects, a first-in-order iteration of the loop may utilize values loaded by the pre-header code, for example, the initial values, e.g., as described below.

In some demonstrative aspects, compiler 160 may be configured to configure the pre-header code and the loop code for the time-shifted scheme, for example, based on the load operations to be performed by the same AGU, e.g., as follows:

| | |
|---|---|
| • | In the loop's pre-header, add MaxTS loads/bumps: %p_i = agu.load( ); |
| | agu.bump( ); (0 <= I < MaxTS) |
| • | In the loop, add phi's chain of length MaxTS: %q_i = phi(%p_i: Pre-header, |
| | %q_(i+1): Loop) (0 <= i < MaxTS) |
| • | In the loop, after the phi's chain, add one load and one bump: %q_MaxTS = |
| | agu.load( ); agu.bump( ); |
| • | Use the %q_i (0 <= i <= MaxTS) in the loop. |

wherein MaxTS denotes a number of iterations, for which results are stored and loaded inside the loop, for example, in order to use the results later.

For example, the value of MaxTS may be based on a count of iterations to be performed between a load operation corresponding to a minimal offset and a load operation corresponding to a maximal offset of the load operations to be performed by the same AGU.

For example, the value of MaxTS may indicate for a value used in a current iteration, how many iterations ago it was loaded from the buffer, e.g., by a load instruction. For example, the value of MaxTS may use the maximum value over all such values.

For example, the code % val=phi (% a: label1, % b: label2), e.g., % q_i=phi (% p_i: Pre-header, % q_(i+1): Loop) may represent a conditional instruction (also referred to as “conditional assignment instruction”), in which % val gets the value % a, for example, if the instructions was reached from code under label1, or the value % b, for example, if the instruction was reached from code under label2.

In some demonstrative aspects, compiler 160 may be configured to generate AGU configuration code, pre-header code, and loop code, for the loop nest of Example 4, for example, according to the time-shift scheme, e.g., as follows:

```
AGU configuration code:
  agu1 = allocate_agu(“load”);
  set_base(agu1, inp1);
  set_y_minmax(agu1, 0, (height − 2) * width);
  set_y_count_stride(agu1, height, width);
  set_y_innerloop(agu1); // Loop interchange
  set_x_minmax(agu1, 0, width);
  VectorizationFactor = 32;
  VectorSize = VectorizationFactor * 1;
  xCount = AlignUpTo(width, VectorizationFactor)/VectorizationFactor;
  set_x_count_stride(agu1, xCount, VectorSize);
  agu2 = allocate_agu(“load”);
  set_base(agu2, inp2);
  set_y_minmax(agu2, 0, (height − 2) * width);
  set_y_count_stride(agu2, height, width);
  set_y_innerloop(agu2); // Loop interchange
  set_x_minmax(agu2, 0, width);
  set_x_count_stride(agu2, xCount, VectorSize);
  agu_out = allocate_agu(“store”);
  set_base(agu_out, out);
  set_y_minmax(agu_out, 0, (height − 2) * width);
  set_y_count_stride(agu_out, height, width);
  set_y_innerloop(agu_out); // Loop interchange
  set_x_minmax(agu_out, 0, width);
  set_x_count_stride(agu_out, xCount, VectorSize);
Pre-header :
  %p0 = agu1.load( ); agu1.bump( );
  %p1 = agu1.load( ); agu1.bump( );
Loop:
  %q0 = phi(%p0: Pre-header , %q1: Loop);
  %q1 = phi(%p1: Pre-header , %q2: Loop);
  %q2 = agu1.load( ); agu1.bump( );
  %val_inp2 = agu2.load( ); agu2.bump( );
  %temp = mul %q0, q1;
  %temp1 = add temp, %q2;
  %result = sub %temp1, %val_inp2;
  agu_out.store(%result); agu_out.bump( );
  br(Loop);
```

### Example (6)

In some demonstrative aspects, as shown by Example 6, the AGU configuration code may include the loop-interchange instruction for the Y-dimension, for example, for all of the AGUs.

For example, as shown by Example 6, the AGU configuration code may include the loop-interchange instruction set_y_innerloop(agu1) for the agu1, the loop-interchange instruction set_y_innerloop(agu2) for the agu2, and set_y_innerloop(agu_out) for the agu_out.

In some demonstrative aspects, as shown by Example 6, the AGU configuration code may include the same count parameter in the Y-dimension for all of the plurality of AGUs.

For example, as shown by Example 6, the AGU configuration code may include the instruction set_y_count_stride(agu1, height, width) for agu1, the instruction set_y_count_stride(agu2, height, width) for agu2, and the instruction set_y_count_stride(agu_out, height, width) for agu_out.

For example, as shown by Example 6, the same count parameter in the Y-dimension may be determined, for example, based on the count parameter of the Y loop, the maximal offset of the three load operations, and the minimal offset of the three load operations, e.g., as follows:

$$Count ( yDim ) = ( MaxYOffset - MinYOffset ) + Count ( LoopYDim ) = ( 2 - 0 ) + ( height - 2 ) = height$$

In some demonstrative aspects, a count of the pre-header AGU load instructions may be based, for example, on a value of MaxTS, e.g., MaxTS=2.

For example, as shown by Example 6, the pre-header code may include two pre-header AGU load instructions, e.g., % p0=agu1.load( ) agu1.bump( ) and % p1=agu1.load( ) agu1.bump( ) to be executed by the same agu1.

In some demonstrative aspects, as shown by Example 6, the two pre-header AGU load instructions, e.g., % p0=agu1.load( ) agu1.bump( ) and % p1=agu1.load( ) agu1.bump( ) may be used to load initial values for the AGU load iterations.

In some demonstrative aspects, as shown by Example 6, the loop code may include two conditional assignment instructions, e.g., % q0=phi (% p0: Pre-header, % q1: Loop); % q1=phi (% p1: Pre-header, % q2: Loop), for example, to assign (store) to a register results of the AGU load iterations by the same agu1, for example, based on the phi operation.

In some demonstrative aspects, as shown by Example 6, the loop code may include a single assignment (store) instruction, e.g., % q2=agu1.load( ) agu1.bump( ) for example, to load and assign (store) to a register results of a current AGU load iteration by the same agu1.

For example, according to the code of Example 6, the pre-header instruction op0=agu1.load( ) agu1.bump( ) may be configured to assign (store) to the register op0 a first value loaded by the agu1, e.g., corresponding to the load operation inp1[index].

For example, according to the code of Example 6, the pre-header instruction % p1=agu1.load( ) agu1.bump( ) may be configured to assign (store) to the register opl a second value loaded by the agu1, e.g., corresponding to the load operation inp1[index+width].

For example, according to the code of Example 6, the loop instruction % q0=phi (% p0: Pre-header, % q1: Loop) may be configured to assign (store) to the register % q0 the first value loaded by the agu1, e.g., corresponding to the load operation inp1[index], for example, in a first-in-order iteration of the loop; or the value from the register % q1, e.g., corresponding to the load operation inp1[index], for example, in a non-first-in-order iteration of the loop, e.g., which is inp1[index+width] relative to a previous iteration.

For example, according to the code of Example 6, the loop instruction % q1=phi (% p1: Pre-header, % q2: Loop) may be configured to assign (store) to the register % q1 the second value loaded by the agu1, e.g., corresponding to the load operation inp1[index+width], for example, in a first-in-order iteration of the loop; or the value from the register % q2, e.g., corresponding to the load operation inp1[index+width], for example, in a non-first-in-order iteration of the loop, e.g., which is inp1[index+2*width] relative to a previous iteration.

For example, according to the code of Example 6, the loop instruction % q2=agu1.load( ) agu1.bump( ) may be configured to assign (store) to the register % q2 a value loaded by the agu1 in the current loop, e.g., corresponding to the load operation inp1[index+2*width].

In some demonstrative aspects, compiler 160 may be configured to compile a source code 112 of another executed program to be executed on a vector processor including a plurality of AGUs, e.g., as described below. For example, the vector processor may include four AGUs.

For example, compiler 160 may identify based on source code 112 a loop nest including five memory access operations, e.g., as follows:

```
for(int y = 0; y < height − 2; y++) {
  for(int x = 0; x < width − 3; x++) {
    int index = y * width + x;
    out1[index] = inp1[index] + inp1[index + 2 * width + 3];
    out2[index] = inp2[index];
  }
}
```

### Example (7)

For example, as shown by Example 7, the loop nest may include an outer loop (y loop) along a dimension (Y-dimension) based on a variable height, and an inner loop (x loop) along a dimension (X-dimension) based on a variable width.

For example, as shown by Example 7, the loop nest may include two load operations to a same memory pointer, denoted inp1, with different two-dimension (2D) offsets, e.g., offsets different in two dimensions.

For example, the loop nest may include a first load operation, e.g., inp1[index], to the memory pointer inp1 with a first 2D offset, e.g., index, which may have an offset of 0 in the Y-dimension and an offset 0 in the X-dimension.

For example, the loop nest may include a second load operation, e.g., inp1[index+2*width+3], to the memory pointer inp1 with a second 2D offset, e.g., index+2*width+3, which may have an offset of 2 (*width) in the Y-dimension and an offset of 3 in the X-dimension.

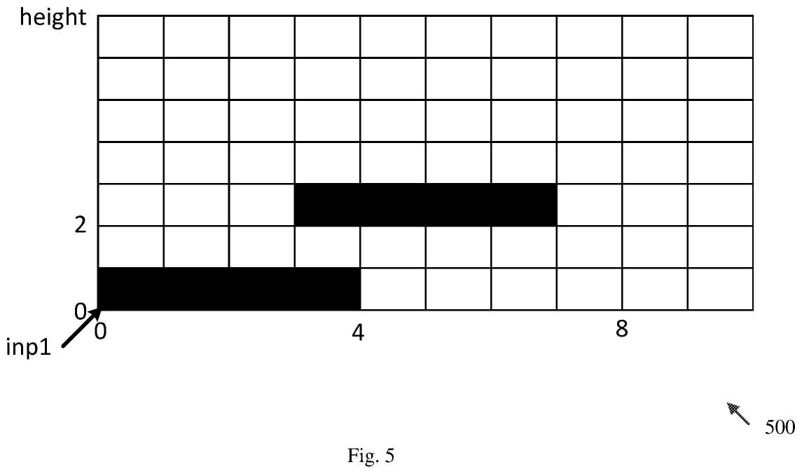

Reference is made to FIG. 5, which schematically illustrates a memory access scheme 500 to load data from a memory with respect to a memory pointer, in accordance with some demonstrative aspects.

In one example, memory access scheme 500 may demonstrate memory accesses with respect to a same memory pointer, denoted inp1, for example, according to the load operations of inp1[index] and inp1[index+2*width+3] of Example 7.

As shown in FIG. 5, the two load operations of inp1[index] and inp1[index+2*width+3] of Example 7 may load data with different 2D offsets with respect to the same memory pointer inp1.

As shown in FIG. 5, the first load operation, e.g., inp1[index], may have an offset of 0 in the Y-dimension and an offset 0 in the X-dimension.

As shown in FIG. 5, the second load operation, e.g., inp1[index+2*width+3], may have an offset of 2 (*width) in the Y-dimension, and an offset of 3 in the X-dimension.

For example, an implementation requiring the use of a different AGU for each memory access with a different offset may require, for example, a total 5 AGUs to handle the memory access operations of Example 7. For example, a first AGU may be used to handle the store operation out1 [index], a second AGU may be used to handle the store operation out2 [index], a third AGU may be used to handle the load operation inp2[index], and two additional AGUs may be used to handle the two load operations with respect to the memory pointer inp1, e.g., inp1[index] and inp1[index+2*width+3]. According to this example, a processor may not be able to handle the memory access operations of Example 7, for example, if a count of available AGUs of the processor is less than 5.

Referring back to FIG. 1, in some demonstrative aspects, compiler 160 may be configured to configure the loop nest of Example 7, for example, according to a combination of the extra-dimension configuration scheme and the time-shift scheme, e.g., as described below.

In some demonstrative aspects, the extra-dimension configuration scheme may be utilized, for example, to configure the loop nest based on the offset in the Y-dimension, e.g., 2*width, e.g., as described below.

In some demonstrative aspects, the time-shift scheme may be utilized, for example, to configure the loop nest based on the offset in the X-dimension, e.g., +3, e.g., as described below.

In some demonstrative aspects, compiler 160 may identify the two load operations to the same memory pointer inp1 with the different 2D offsets, e.g., the load operations inp1[index], and inp1[index+2*width+3], for example, based on the loop nest of Example 7.

In some demonstrative aspects, compiler 160 may be configured to verify that the two load operations to the same memory pointer have the same strides in all loops of the loop nest of Example 7.

For example, compiler 160 may verify that all two load operations inp1[index], and inp1[index+2*width+3] have the same strides in the inner loop X, e.g., Step (X-Loop)=VectorSize, and in the outer loop Y, e.g., Step (Y-Loop)=width.

In some demonstrative aspects, compiler 160 may be configured to identify that the offsets of the operations inp1[index], and inp1[index+2*width+3] are different in the Y-dimension and in the X-dimension.

For example, the load operation inp1[index] may have an offset of 0 (*width) in the Y-dimension and an offset of 0 in the X-dimension; and the load operation inp1[index+2*width+3] may have an offset of 2 (*width) in the Y-dimension, and an offset of 3 in the X-dimension.

In some demonstrative aspects, compiler 160 may be configured to verify whether the predefined conditions for the time-shift scheme are met with respect to the X-dimension of the loop nest of Example 7.

In some demonstrative aspects, compiler 160 may determine that the predefined conditions for the time-shift scheme are met with respect to the X-dimension of the loop nest of Example 7.

For example, compiler 160 may determine that both memory access operations are load operations; that the differences between the offsets of all load operations are constant, e.g., 3; that any bounds of the two load operations are the same; that the loop nest does not include side effects; and/or that the two load operations are not masked.

In some demonstrative aspects, compiler 160 may be configured to verify whether the predefined conditions for the extra-dimension configuration scheme are met with respect to the Y-dimension of the loop nest of Example 7.

In some demonstrative aspects, compiler 160 may determine that the predefined conditions for the extra-dimension configuration scheme are met with respect to the Y-dimension of the loop nest of Example 7.

For example, compiler 160 may determine that the number of dimensions of the loop, e.g., two dimensions, meets the condition on the number of dimensions, e.g., #loop-dimensions=2<=3; that the differences between the offsets are all equal, e.g., since there are only two load operations; and/or that there are no bounds or pass-throughs.

In some demonstrative aspects, compiler 160 may be configured to set AGU configuration code for the plurality of AGUs of the target processor, for example, to set an AGU configuration, e.g., a vertical-horizontal shift (“NarrowRectangle”) configuration, for example, to indicate that a combination of a horizontal time-shift scheme and a vertical extra-dimension configuration scheme may be implemented, e.g., as described below.

In some demonstrative aspects, compiler 160 may be configured to set AGU configuration code for the AGU, for example, according to the extra-dimension configuration scheme, e.g., as described below.

In some demonstrative aspects, compiler 160 may be configured to set an access-count parameter, denoted C, corresponding to the additional dimension, for example, based on the total count of memory accesses to which the extra-dimension configuration scheme is to be applied.

For example, compiler 160 may identify that the loop nest of Example 7 includes the two load operations inp1[index], and inp1[index+2*width+3]. Accordingly, compiler 160 may set the count parameter C to two, e.g., C=Count (Extra-dim)=#AccessesInTheGroup=2.

In some demonstrative aspects, compiler 160 may be configured to set a step parameter of the additional dimension of the AGU, for example, based on the difference between consecutive offsets of the memory accesses to which the extra-dimension configuration scheme is to be applied.

For example, compiler 160 may identify that the difference between the two “consecutive” offsets of the two load operations is equal to 2 (*width), e.g., as described above. Accordingly, compiler 160 may set the step parameter of the additional dimension of the AGU to be 2*width, e.g., Step (Extra-dim)=DifferenceBetween2ClosestOffsets*Stride=2*width.

In some demonstrative aspects, compiler 160 may be configured to set AGU configuration code for the plurality of AGUs, for example, according to the time-shift scheme, e.g., as described below.

In some demonstrative aspects, compiler 160 may be configured to set a same count parameter, denoted Count (xDim), in a time-shifted dimension, e.g., the X-dimension, for example, for all of the AGUs, e.g., as described below.

In some demonstrative aspects, compiler 160 may be configured to set the same count parameter for the time-shifted dimension, for example, based on a count parameter of the loop of the time-shifted dimension, a maximal offset of the load operations to the same memory pointer, and a minimal offset of the load operations, e.g., as follows:

$$Count ( xDim ) = Align Up To ( ( MaxXOffset - MinXOffset ) + Count ( LoopXDim ) , VF ) / VF$$

wherein MaxXOffset denotes a maximum offset of the memory access operations in the time-shifted dimension, e.g., the X-dimension, over all of the load operations covered by the AGUs,
wherein MinXOffst denotes a minimum offset of the memory access operations in the time-shifted dimension, e.g., the X-dimension, over all of the load operations covered by the AGUs,
wherein VF denotes a vectorization factor (VectorizationFactor), and
wherein the operation AlignUpTo(a,b) may be configured to align-up a to an integer multiple of b.

For example, the VF may be similar to the VectorSize parameter. For example, the VF may indicate how many elements each vector includes. For example, an element may be a char, short (two bytes), int, or the like.

For example, the VF may be based on a product of a number of elements and an element size (bytes), e.g., VectorSize=number of elements*element size (bytes)=VF*element size. For example, when the element size is 1, the VF may be the same as the VectorSize.

For example, the operation alignup(a,b) may include aligning up a value of a to a closest integer multiple of b. For example, the operation alignup (17,5) may result in a value of 20, e.g., a lowest integer greater than or equal to 17, which is an integer multiple of 5. For example, the operation AlignUpTo ((MaxXOffset−MinXOffset)+Count (LoopXDim), VF)/VF, may be utilized to ensure that the division by VF may result with an integer value, for example, to ensure that the count value Count (xDim) is an integer.

In some demonstrative aspects, compiler 160 may be configured to generate loop code, for example, based on the loop nest of Example 7, and pre-header code to be executed before the header of the loop code.

In some demonstrative aspects, compiler 160 may be configured to configure the loop code to load only current values, e.g., C current values, inside the loop, for example, based on the total count of memory accesses by the same AGU, which is utilized to implement the plurality of load operations. For example, the loop code may include only two load operations, e.g., as described below.

In some demonstrative aspects, compiler 160 may be configured to generate the pre-header code to load initial values by the same AGU, which is utilized to implement the plurality of load operations, e.g., prior to execution of the loop.

For example, the pre-header code may include a plurality of AGU load instructions to be executed, for example, by the same AGU, which is utilized to implement the plurality of load operations, for example, prior to execution of the loop, e.g., as described below.

In some demonstrative aspects, compiler 160 may be configured to remember and/or keep, e.g., assign (store) to registers, other values from previous AGU load iterations in the loop, e.g., as described below.

In some demonstrative aspects, a first-in-order iteration of the loop may utilize values loaded by the pre-header code, for example, the initial values, e.g., as described below.

In some demonstrative aspects, compiler 160 may be configured to shuffle between the initial values and the current values, e.g., in a first-in-order iteration of the loop, and to shuffle adjacent values of two consecutive iterations, for example, when needed, e.g., for all other iterations.

In some demonstrative aspects, compiler 160 may be configured to configure the pre-header code and the loop code for the time-shifted scheme, for example, based on the load operations to be performed by the same AGU, e.g., as follows:

In the loop's pre-header, add MaxTS * C loads/bumps: %p_i = agu.load( );
agu.bump( ); (0 <= i < MaxTS * C)
In the loop, add phi's chain of length MaxTS * C: %q_i = phi(%p_i: Pre-header
, %q_(i+C): Loop) (0 <= i < MaxTS * C)
In the loop, after the phi's chain, add C loads/bumps: %q_i = agu.load( );
agu.bump( ); (MaxTS * C <= i < (MaxTS + 1) * C)
Use the shuffle(%q_i, %q_(i+C), Elements) (0 <= i < MaxTS * C) in the loop.

wherein MaxTS*C denotes a product of a number of iterations, for which results are stored and loaded inside the loop, multiplied by the number of loads in each iteration, for example, in order to use the results later,
and wherein the code shuffle (% q_i, % q_(i+C), Elements), e.g., % val1=shuffle (% q1, % q3, [3, 4, 5, . . . , 33, 34]) may be configured to shuffle between adjacent results of the AGU load iterations.

For example, the value of MaxTS*C may indicate for a value used in a current iteration, how many iterations ago it was loaded from the buffer, e.g., by a load instruction. For example, the value of MaxTS*C may use the maximum value over all such values.

In some demonstrative aspects, compiler 160 may be configured to generate AGU configuration code, pre-header code, and loop code, for the loop nest of Example 7, for example, according to the vertical-horizontal shift scheme, e.g., as follows:

```
AGU configuration code:
  agu1 = allocate_agu(“load”);
  set_base(agu1, inp1);
  set_y_minmax(agu1, 0, (height − 2) * width);
  set_y_count_stride(agu1, height − 2, width);
  set_x_minmax(agu1, 0, width);
  VF = VectorizationFactor = 32;
  VectorSize = VF * 1;
  XCount = AlignUpTo((width − 3)+ 3, VF)/VF;
  set_x_count_stride(agu1, XCount, VectorSize);
  set_z_count_stride(agu1, 2, 2 * width)
  agu2 = allocate_agu(“load”);
  set_base(agu2, inp2);
  set_y_minmax(agu2, 0, (height − 2) * width);
  set_y_count_stride(agu2, height − 2, width);
  set_x_minmax(agu2, 0, width);
  set_x_count_stride(agu2, XCount, VectorSize);
  agu_out1 = allocate_agu(“store”);
  set_base(agu_out1, out1);
  set_y_minmax(agu_out1, 0, (height − 2) * width);
  set_y_count_stride(agu_out1, height − 2, width);
  set_x_minmax(agu_out1, 0, width);
  set_x_count_stride(agu_out1, XCount, VectorSize);
  agu_out2 = allocate_agu(“store”);
  set_base(agu_out2, out2);
  set_y_minmax(agu_out2, 0, (height − 2) * width);
  set_y_count_stride(agu_out2, height − 2, width);
  set_x_minmax(agu_out2, 0, width);
  set_x_count_stride(agu_out2, XCount, VectorSize);
Preheader:
  %p0 = agu1.load( ); agu1.bump( );
  %p1 = agu1.load( ); agu1.bump( );
Loop:
  %q0 = phi(%p0: Preheader, %q2: Loop);
  %q1 = phi(%p1: Preheader, %q3: Loop);
  %q2 = agu1.load( ); agu1.bump( );
  %q3 = agu1.load( ); agu1.bump( );
  %val_inp2 = agu2.load( ); agu2.bump( );
  %val0 = %q0;
  // Looks at the 32-elements-vectors %q1, %q3 as if they were one vector of
  64elements, and builds a new 32-elements-vector
  // taking the elements 3, 4, 5, ..., 33, 34.
  %val1 = shuffle(%q1, %q3, [3, 4, 5, ..., 33, 34])
  %result = add %val0, %val1;
  agu_out1.store(%result); agu_out1.bump( );
  agu_out2.store(%val_inp2); agu_out2.bump( );
  br(Loop);
```

### Example (8)

In some demonstrative aspects, as shown by Example 8, the AGU configuration code for agu1 may include AGU configuration code for an additional dimension, e.g., the dimension z.

In some demonstrative aspects, as shown by Example 8, the additional dimension, e.g., the dimension z, may be configured, for example, in addition to the dimension x, which may be configured based on the X-loop, and the dimension y, which may be configured based on the Y-loop.

In some demonstrative aspects, the AGU configuration code for agu1 may include AGU configuration code, for example, to set the count parameter and the step (stride) parameter for the additional dimension z, e.g., according to the vertical extra-dimension configuration for the dimension y.

For example, as shown in Example 8, the AGU configuration code for agu1 may include AGU configuration code, e.g., set_z_count_stride(agu1, 2, 2*width), for example, to set the count parameter for the dimension z to 2, and to set the stride (step) parameter for the dimension z to 2*width.

In some demonstrative aspects, compiler 160 may be configured to configure the AGU configuration code to set the same count parameter in the X-dimension for all of the AGUs, e.g., according to the horizontal time-shift for the X-dimension.

For example, as shown in Example 8, the AGU configuration code may include instructions to set the same count parameter in the X-dimension for all of the AGUs. For example, the AGU configuration code may include the instruction set_x_count_stride(agu1, XCount, width) for agu1, the instruction set_x_count_stride(agu2, XCount, width) for agu2, and the instruction set_x_count_stride(agu_out, XCount, width) for agu_out.

For example, as shown by Example 8, the same count parameter in the X-dimension may be determined, for example, based on the count parameter of the x loop; the maximal offset of all load operations, e.g., two load operations, covered by the AGU; the minimal offset of the two load operations; and the vectorization factor, e.g., as follows:

$$XCount = Count ( XDim ) = AlignUpTo ( ( MaxXOffset - MinXOffset ) + Count ( LoopXdim ) , VF ) / VF = AlignUpT o ( ( width - 3 ) + 3 , VF ) / VF$$

In some demonstrative aspects, as shown by Example 8, the pre-header code may include MaxTS*C=2 AGU load instructions to be executed by the same agu1, for example, according to the horizontal time-shift for the X-dimension.

For example, the two pre-header AGU load instructions, e.g., % p0=agu1.load( ) agu1.bump( ) and % p1=agu1.load( ) agu1.bump( ) may be used, for example, for loading by the agu1 initial values for the AGU load iterations.

In some demonstrative aspects, as shown by Example 8, the loop code may include two conditional assignment instructions, e.g., % q0=phi (% p0: Pre-header, % q2: Loop); % q1=phi (% p1: Pre-header, % q3: Loop), for example, to assign (store) to a register results of the AGU load iterations by the same agu1.

In some demonstrative aspects, as shown by Example 8, the two conditional assignment instructions, e.g., % q0=phi (% p0: Pre-header, % q2: Loop); % q1=phi (% p1: Pre-header, % q3: Loop), may be based, for example, on the phi operation.

In some demonstrative aspects, as shown by Example 8, the loop code may include two assignment instructions, e.g., % q2=agu1.load( ) agu1.bump(,), and % q3=agu1.load( ) agu1.bump(,), for example, to load and assign (store) to a register results of a current loop iteration by the same agu1.

For example, the instruction % q2=agu1.load( ) agu1.bump(,) may be configured to assign (store) to the register % q2 a value loaded by the agu1 in a first iteration over the dimension z, e.g., corresponding to the load operation inp1[index].

For example, the instruction % q3=agu1.load( ) agu1.bump( ) may be configured to assign (store) to the register % q3 a value loaded by the agu1 in a second iteration over the dimension z, e.g., corresponding to the load operation inp1[index+2*width+3].

For example, according to the code of Example 8, the pre-header instruction % p0=agu1.load( ) agu1.bump( ) may be configured to assign (store) to the register Yop0 a first value loaded by the agu1, e.g., corresponding to the load operation inp1[index], for example, according to the horizontal time-shift for the X-dimension.

For example, according to the code of Example 8, the pre-header instruction opl=agu1.load( ) agu1.bump( ) may be configured to assign (store) to the register opl a second value loaded by the agu1, e.g., corresponding to the load operation inp1[index+2*width], for example, according to the horizontal time-shift for the X-dimension.

For example, according to the code of Example 8, the loop instruction % q0=phi (% p0: Pre-header, % q2: Loop) may be configured to assign (store) to the register % q0 the first value loaded by the agu1, e.g., corresponding to the load operation inp1[index], for example, in a first-in-order iteration of the loop; or the value from the register % q2, e.g., corresponding to the load operation inp1[index], for example, in a non-first-in-order iteration of the loop.

For example, according to the code of Example 8, the loop instruction % q1=phi (% p1: Pre-header, % q3: Loop) may be configured to assign (store) to the register % q1 the second value loaded by the agu1, e.g., corresponding to the load operation inp1[index+2*width+3], for example, in a first-in-order iteration of the loop; or the value from the register % q3, e.g., corresponding to the load operation inp1[index+2*width], for example, in a non-first-in-order iteration of the loop.

In some demonstrative aspects, as shown by Example 8, the loop code may include a shuffle instruction, e.g., % val1=shuffle (% q1, % q3, [3, 4, 5, . . . , 33, 34]), for example, to shuffle results of previous AGU load iterations and current AGU load iteration, for example, with respect to the load operation inp1[index+2*width+3].

In one example, a size of the register % q1 and a size the register % q3 may be 32 elements.

For example, the register % q1 may represent a first vector in the third row of the scheme of FIG. 5, e.g., covering blocks 0-4 of the third row, for example, in case VectorSize=VF=4. For example, the register % q3 may represent a second vector in the third row of the scheme of FIG. 5, e.g., covering blocks 4-8 of the third row.

For example, the load operation inp1[index+2*width+3] may include a combination of an end portion of the register % q1, e.g., corresponding to the block 4 in the third row of the scheme of FIG. 5, and a beginning portion of the register % q3, e.g., corresponding to the blocks 5-7 in the third row of the scheme of FIG. 5. Accordingly, the shuffle operation may be configured to concatenate vectors of two registers, e.g., the register % q1 and the register % q3, to a 64-element vector, and to use a needed 32-element part of the 64-element vector, e.g., corresponding to the load operation inp1[index+2*width+3].

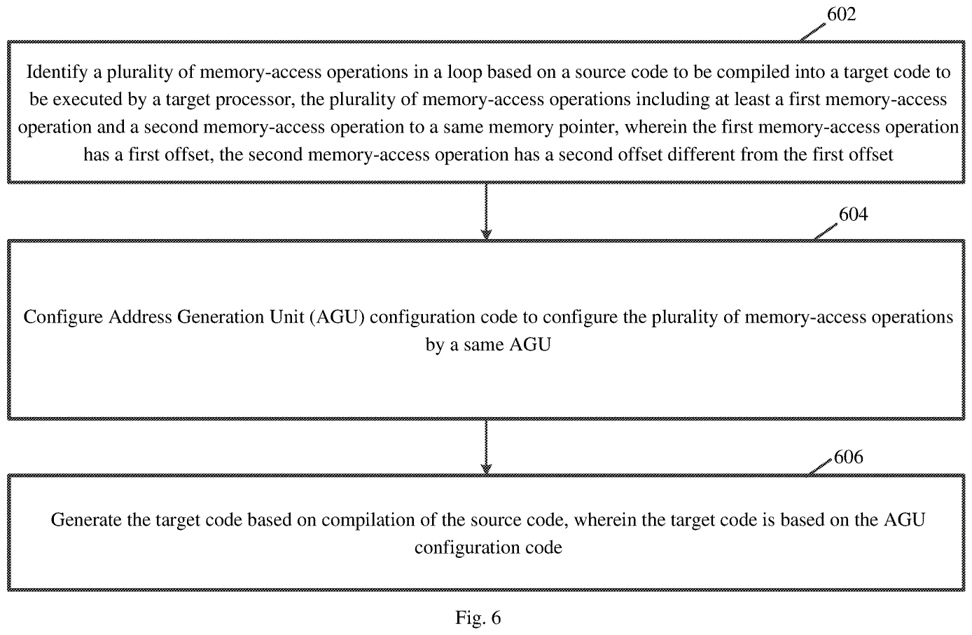

Reference is made to FIG. 6, which schematically illustrates a method of compiling code for a processor. For example, one or more operations of the method of FIG. 6 may be performed by a system, e.g., system 100 (FIG. 1); a device, e.g., device 102 (FIG. 1); a server, e.g., server 170 (FIG. 1); and/or a compiler, e.g., compiler 160 (FIG. 1), and/or compiler 200 (FIG. 2).

In some demonstrative aspects, as indicated at block 602, the method may include identifying a plurality of memory-access operations in a loop based on a source code to be compiled into a target code to be executed by a target processor. For example, the plurality of memory-access operations may include at least a first memory-access operation and a second memory-access operation to a same memory pointer. For example, the first memory-access operation may have a first offset, and the second memory-access operation may have a second offset, e.g., different from the first offset. For example, compiler 160 (FIG. 1) may be configured to identify the plurality of memory-access operations in the loop, for example, based on the source code 112 (FIG. 1), e.g., as descried above.

In some demonstrative aspects, as indicated at block 604, the method may include configuring AGU configuration code to configure the plurality of memory-access operations by a same AGU. For example, compiler 160 (FIG. 1) may be configured to configure the AGU configuration code to configure the plurality of memory-access operations by the same AGU, e.g., as descried above.

In some demonstrative aspects, as indicated at block 606, the method may include generating the target code based on compilation of the source code. For example, the target code may be based on the AGU configuration code. For example, compiler 160 (FIG. 1) may be configured to generate target code 115 (FIG. 1), which is based on the AGU configuration code, for example, based on compilation of the source code 112 (FIG. 1), e.g., as descried above.

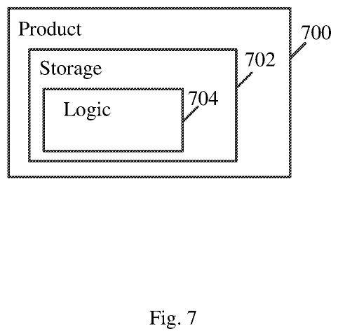

Reference is made to FIG. 7, which schematically illustrates a product of manufacture 700, in accordance with some demonstrative aspects. Product 700 may include one or more tangible computer-readable (“machine-readable”) non-transitory storage media 702, which may include computer-executable instructions, e.g., implemented by logic 704, operable to, when executed by at least one computer processor, enable the at least one computer processor to implement one or more operations at device 102 (FIG. 1), server 170 (FIG. 1), and/or compiler 160 (FIG. 1), to cause device 102 (FIG. 1), server 170 (FIG. 1), and/or compiler 160 (FIG. 1) to perform, trigger and/or implement one or more operations and/or functionalities, and/or to perform, trigger and/or implement one or more operations and/or functionalities described with reference to the FIGS. 1-6, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 700 and/or machine-readable storage media 702 may include one or more types of computer-readable storage media capable of storing data, including volatile memory, non-volatile memory, removable or non-removable memory, erasable or non-erasable memory, writeable or re-writeable memory, and the like. For example, machine-readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes a product comprising one or more tangible computer-readable non-transitory storage media comprising computer-executable instructions operable to, when executed by at least one processor, enable the at least one processor to cause a compiler to identify a plurality of memory-access operations in a loop based on a source code to be compiled into a target code to be executed by a target processor, the plurality of memory-access operations comprising at least a first memory-access operation and a second memory-access operation to a same memory pointer, wherein the first memory-access operation has a first offset, the second memory-access operation has a second offset different from the first offset; configure Address Generation Unit (AGU) configuration code to configure the plurality of memory-access operations by a same AGU; and generate the target code based on compilation of the source code, wherein the target code is based on the AGU configuration code.

Example 2 includes the subject matter of claim 1, and optionally, wherein the instructions, when executed, cause the compiler to configure the AGU configuration code to configure the plurality of memory-access operations based on a dimension of the loop, wherein the first offset comprises a first integer multiple of the dimension of the loop, and the second offset comprises a second integer multiple of the dimension of the loop.

Example 3 includes the subject matter of claim 1 or 2, and optionally, wherein the instructions, when executed, cause the compiler to, based on a determination that a difference between the first offset and the second offset is independent of a dimension of the loop, configure the AGU configuration code to configure the plurality of memory-access operations based on the difference between the first offset and the second offset.

Example 4 includes the subject matter of any one of claims 1-3, and optionally, wherein the instructions, when executed, cause the compiler to, based on a determination that a difference between the first offset and the second offset is based on an integer multiple of a dimension of the loop and is based on a dimension-independent value, which is independent of the dimension of the loop, configure the AGU configuration code to configure a first dimension of the AGU based on the dimension of the loop, and to configure a second dimension of the AGU based on the independent value.

Example 5 includes the subject matter of any one of claims 1-4, and optionally, wherein the plurality of memory-access operations comprises a third memory-access operation to the same memory pointer, the third memory-access operation has a third offset different from the first offset and the second offset, wherein the AGU configuration code is to configure the plurality of memory-access operations by the same AGU based on the third offset.

Example 6 includes the subject matter of any one of claims 1-5, and optionally, wherein the loop comprises a first loop, wherein the first loop is nested in a second loop, wherein the instructions, when executed, cause the compiler to configure the AGU configuration code based on the second loop.

Example 7 includes the subject matter of claim 6, and optionally, wherein the instructions, when executed, cause the compiler to configure the AGU configuration code comprising first dimension code to configure a first dimension of the AGU based on the first loop, second dimension code to configure a second dimension of the AGU based on the plurality of memory-access operations, and third dimension code to configure a third dimension of the AGU based on the second loop.

Example 8 includes the subject matter of claim 6, and optionally, wherein the instructions, when executed, cause the compiler to, based on a determination that a difference between the first offset and the second offset is based on a dimension of the second loop, configure the AGU configuration code comprising a loop-interchange instruction to instruct a loop interchange between a dimension of the AGU corresponding to the first loop and a dimension of the AGU corresponding to the second loop.

Example 9 includes the subject matter of any one of claims 1-8, and optionally, wherein the AGU configuration code comprises first dimension code to configure a first dimension of the AGU based on the loop, and second dimension code to configure a second dimension of the AGU based on the plurality of memory-access operations.

Example 10 includes the subject matter of claim 9, and optionally, wherein the first dimension code is configured to set a count parameter of the first dimension of the AGU based on a count parameter of the loop, and to set a step parameter of the first dimension of the AGU based on a step parameter of the loop, and wherein the second dimension code is configured to set a count parameter of the second dimension of the AGU based on a total count of memory-access operations in the plurality of memory-access operations, and to set a step parameter of the second dimension of the AGU based on a difference between the first offset and the second offset.

Example 11 includes the subject matter of claim 9 or 10, and optionally, wherein the instructions, when executed, cause the compiler to generate loop code based on the loop, wherein the target code is based on the loop code, wherein the loop code comprises a plurality of memory-access instructions to be executed by the same AGU, wherein the plurality of memory-access instructions correspond to the plurality of memory-access operations, respectively.

Example 12 includes the subject matter of any one of claims 9-11, and optionally, wherein the plurality of memory-access operations comprises a third memory-access operation to the same memory pointer, the third memory-access operation has a third offset different from the first offset and the second offset, wherein the instructions, when executed, cause the compiler to generate loop code comprising first, second, and third memory-access instructions to be executed by the same AGU based on the first, second and third memory-access instructions, respectively, wherein the target code is based on the loop code.

Example 13 includes the subject matter of claim 12, and optionally, wherein the instructions, when executed, cause the compiler to, based on a determination that a first difference between the first offset and the second offset is equal to a second difference between the second offset and the third offset, configure the second dimension of the AGU based on the second difference.

Example 14 includes the subject matter of any one of claims 9-13, and optionally, wherein the loop comprises a first loop, wherein the first loop is nested in a second loop, wherein the AGU configuration code comprises third dimension code to configure a third dimension of the AGU based on the second loop.

Example 15 includes the subject matter of any one of claims 9-14, and optionally, wherein the instructions, when executed, cause the compiler to configure the second dimension of the AGU based on the plurality of memory-access operations, based on a determination that a count of dimensions of the first loop is less than a count of dimensions supported by the same AGU.

Example 16 includes the subject matter of any one of claims 9-15, and optionally, wherein the instructions, when executed, cause the compiler to configure the second dimension of the AGU based on the plurality of memory-access operations, based on a determination that the plurality of memory-access operations have no bounds and no pass-throughs.

Example 17 includes the subject matter of any one of claims 9-16, and optionally, wherein the instructions, when executed, cause the compiler to configure the second dimension of the AGU based on the plurality of memory-access operations, based on a determination that differences between consecutive offsets of the plurality of memory-access operations are the same.

Example 18 includes the subject matter of any one of claims 9-17, and optionally, wherein the instructions, when executed, cause the compiler to configure the second dimension of the AGU based on the plurality of memory-access operations, based on a determination that a count of dimensions of the first loop is less than a count of dimensions supported by the same AGU, that the plurality of memory-access operations have no bounds and no pass-throughs, and that differences between consecutive offsets of the plurality of memory-access operations are the same.

Example 19 includes the subject matter of any one of claims 1-18, and optionally, wherein the AGU configuration code comprises code to configure the same AGU according to a time-shift scheme, the time-shift scheme configured to implement the plurality of memory-access operations as a plurality of time-shifted memory-access operations of the same AGU during a plurality of respective loop iterations.

Example 20 includes the subject matter of claim 19, and optionally, wherein the AGU configuration code comprises a loop-interchange instruction for a dimension of the AGU corresponding to the loop, wherein the loop-interchange instruction is configured to instruct a loop interchange between the dimension of the AGU corresponding to the loop and another dimension of the AGU corresponding to an outer loop.

Example 21 includes the subject matter of claim 19, and optionally, wherein the instructions, when executed, cause the compiler to configure the AGU configuration code comprising a loop-interchange instruction for a dimension of the AGU corresponding to the loop, based on a determination that a difference between the first offset and the second offset is based on a dimension of an other loop comprising the loop, wherein the loop-interchange instruction is configured to instruct a loop interchange between the dimension of the AGU corresponding to the loop and another dimension of the AGU corresponding to the other loop.

Example 22 includes the subject matter of any one of claims 19-21, and optionally, wherein the AGU configuration code is configured to set a same count parameter for all AGUs to perform memory-access operations during the loop, wherein the same count parameter is based on a count parameter of the loop, a maximal offset of the plurality of memory-access operations, and a minimal offset of the plurality of memory-access operations.

Example 23 includes the subject matter of claim 22, and optionally, wherein the AGU configuration code is to set the same count parameter, denoted Count, as follows:

$$Count = Align Up To ( ( MaxXOffset - MinXOffset ) + Count ( Loop ) , VF ) / VF$$

wherein MaxXOffset denotes the maximal offset of the plurality of memory access operations,
wherein MinXOffst denotes the minimal offset of the plurality of memory access operations,
wherein VF denotes a vectorization factor,
wherein Count (Loop) denotes the count parameter of the loop, and wherein the operation AlignUpTo(a,b) is to align-up a to an integer multiple of b.

Example 24 includes the subject matter of any one of claims 19-23, and optionally, wherein the instructions, when executed, cause the compiler to generate loop code based on the loop, and pre-header code to be executed before a header of the loop code, wherein the target code is based on the loop code and the pre-header code, wherein the pre-header code comprises a plurality of AGU load instructions to be executed by the same AGU, wherein a count of AGU load instructions in the plurality of AGU load instructions is based on a count of memory-access operations in the plurality of memory-access operations.

Example 25 includes the subject matter of claim 24, and optionally, wherein the loop code comprises a plurality of store instructions to store results of a respective plurality of AGU load iterations by the same AGU, wherein a count of the plurality of store instructions is based on the count of memory-access operations in the plurality of memory-access operations.

Example 26 includes the subject matter of claim 25, and optionally, wherein the plurality of store instructions is configured to cause the target processor to store a plurality of load results of the plurality of AGU load instructions in the pre-header code at a first-in-order iteration of the plurality of AGU load iterations.

Example 27 includes the subject matter of any one of claims 19-26, and optionally, wherein the instructions, when executed, cause the compiler to configure the AGU configuration code comprising code to configure the same AGU according to the time-shift scheme, based on a determination that the plurality of memory-access operations comprises only load operations.

Example 28 includes the subject matter of any one of claims 19-27, and optionally, wherein the instructions, when executed, cause the compiler to configure the AGU configuration code comprising code to configure the same AGU according to the time-shift scheme, based on a determination that differences between consecutive offsets of the plurality of memory-access operations are independent of a dimension of the loop.

Example 29 includes the subject matter of any one of claims 19-28, and optionally, wherein the instructions, when executed, cause the compiler to configure the AGU configuration code comprising code to configure the same AGU according to the time-shift scheme, based on a determination that the plurality of memory-access operations have no bounds and no pass-throughs.

Example 30 includes the subject matter of any one of claims 19-29, and optionally, wherein the instructions, when executed, cause the compiler to configure the AGU configuration code comprising code to configure the same AGU according to the time-shift scheme, based on a determination that the plurality of memory-access operations are not masked.

Example 31 includes the subject matter of any one of claims 19-30, and optionally, wherein the instructions, when executed, cause the compiler to configure the AGU configuration code comprising code to configure the same AGU according to the time-shift scheme, based on a determination that the loop does not comprise any side effects.

Example 32 includes the subject matter of any one of claims 19-31, and optionally, wherein the instructions, when executed, cause the compiler to configure the AGU configuration code comprising code to configure the same AGU according to the time-shift scheme, based on a determination that the plurality of memory-access operations comprises only load operations, that differences between consecutive offsets of the plurality of memory-access operations are independent of a dimension of the loop, that the plurality of memory-access operations have no bounds and no pass-throughs, that the plurality of memory-access operations are not masked, and that the loop does not comprise any side effects.

Example 33 includes the subject matter of any one of claims 1-32, and optionally, wherein the plurality of memory-access operations comprises a plurality of load operations.

Example 34 includes the subject matter of any one of claims 1-33, and optionally, wherein the source code comprises Open Computing Language (OpenCL) code.

Example 35 includes the subject matter of any one of claims 1-34, and optionally, wherein the computer-executable instructions, when executed, cause the compiler to compile the source code into the target code according to a Low Level Virtual Machine (LLVM) based (LLVM-based) compilation scheme.

Example 36 includes the subject matter of any one of claims 1-35, and optionally, wherein the target code is configured for execution by a Very Long Instruction Word (VLIW) Single Instruction/Multiple Data (SIMD) target processor.

Example 37 includes the subject matter of any one of claims 1-36, and optionally, wherein the target code is configured for execution by a target vector processor.

Example 38 includes a compiler configured to perform any of the described operations of any of Examples 1-37.

Example 39 includes a computing device configured to perform any of the described operations of any of Examples 1-37.

Example 40 includes a computing system comprising at least one memory to store instructions; and at least one processor to retrieve instructions from the memory and execute the instructions to cause the computing system to perform any of the described operations of any of Examples 1-37.

Example 41 includes a computing system comprising a compiler to generate target code according to any of the described operations of any of Examples 1-37, and a processor to execute the target code.

Example 42 comprises an apparatus comprising means for executing any of the described operations of any of Examples 1-37.

Example 43 comprises an apparatus comprising: a memory interface; and processing circuitry configured to: perform any of the described operations of any of Examples 1-37.

Example 44 comprises a method comprising any of the described operations of any of Examples 1-37.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-39. (canceled)

40. A product comprising one or more tangible computer-readable non-transitory storage media comprising computer-executable instructions operable to, when executed by at least one processor, enable the at least one processor to cause a compiler to:
identify a plurality of memory-access operations in a loop based on a source code to be compiled into a target code to be executed by a target processor, the plurality of memory-access operations comprising at least a first memory-access operation and a second memory-access operation to a same memory pointer, wherein the first memory-access operation has a first offset, the second memory-access operation has a second offset different from the first offset;
configure Address Generation Unit (AGU) configuration code to configure the plurality of memory-access operations by a same AGU; and
generate the target code based on compilation of the source code, wherein the target code is based on the AGU configuration code.

41. The product of claim 40, wherein the instructions, when executed, cause the compiler to configure the AGU configuration code to configure the plurality of memory-access operations based on a dimension of the loop, wherein the first offset comprises a first integer multiple of the dimension of the loop, and the second offset comprises a second integer multiple of the dimension of the loop.

42. The product of claim 40, wherein the instructions, when executed, cause the compiler to, based on a determination that a difference between the first offset and the second offset is independent of a dimension of the loop, configure the AGU configuration code to configure the plurality of memory-access operations based on the difference between the first offset and the second offset.

43. The product of claim 40, wherein the instructions, when executed, cause the compiler to, based on a determination that a difference between the first offset and the second offset is based on an integer multiple of a dimension of the loop and is based on a dimension-independent value, which is independent of the dimension of the loop, configure the AGU configuration code to configure a first dimension of the AGU based on the dimension of the loop, and to configure a second dimension of the AGU based on the independent value.

44. The product of claim 40, wherein the plurality of memory-access operations comprises a third memory-access operation to the same memory pointer, the third memory-access operation has a third offset different from the first offset and the second offset, wherein the AGU configuration code is to configure the plurality of memory-access operations by the same AGU based on the third offset.

45. The product of claim 40, wherein the loop comprises a first loop, wherein the first loop is nested in a second loop, wherein the instructions, when executed, cause the compiler to configure the AGU configuration code based on the second loop.

46. The product of claim 45, wherein the instructions, when executed, cause the compiler to configure the AGU configuration code comprising first dimension code to configure a first dimension of the AGU based on the first loop, second dimension code to configure a second dimension of the AGU based on the plurality of memory-access operations, and third dimension code to configure a third dimension of the AGU based on the second loop.

47. The product of claim 45, wherein the instructions, when executed, cause the compiler to, based on a determination that a difference between the first offset and the second offset is based on a dimension of the second loop, configure the AGU configuration code comprising a loop-interchange instruction to instruct a loop interchange between a dimension of the AGU corresponding to the first loop and a dimension of the AGU corresponding to the second loop.

48. The product of claim 40, wherein the AGU configuration code comprises first dimension code to configure a first dimension of the AGU based on the loop, and second dimension code to configure a second dimension of the AGU based on the plurality of memory-access operations.

49. The product of claim 48, wherein the first dimension code is configured to set a count parameter of the first dimension of the AGU based on a count parameter of the loop, and to set a step parameter of the first dimension of the AGU based on a step parameter of the loop, and wherein the second dimension code is configured to set a count parameter of the second dimension of the AGU based on a total count of memory-access operations in the plurality of memory-access operations, and to set a step parameter of the second dimension of the AGU based on a difference between the first offset and the second offset.

50. The product of claim 48, wherein the instructions, when executed, cause the compiler to generate loop code based on the loop, wherein the target code is based on the loop code, wherein the loop code comprises a plurality of memory-access instructions to be executed by the same AGU, wherein the plurality of memory-access instructions correspond to the plurality of memory-access operations, respectively.

51. The product of claim 48, wherein the plurality of memory-access operations comprises a third memory-access operation to the same memory pointer, the third memory-access operation has a third offset different from the first offset and the second offset, wherein the instructions, when executed, cause the compiler to generate loop code comprising first, second, and third memory-access instructions to be executed by the same AGU based on the first, second and third memory-access instructions, respectively, wherein the target code is based on the loop code.

52. The product of claim 48, wherein the loop comprises a first loop, wherein the first loop is nested in a second loop, wherein the AGU configuration code comprises third dimension code to configure a third dimension of the AGU based on the second loop.

53. The product of claim 48, wherein the instructions, when executed, cause the compiler to configure the second dimension of the AGU based on the plurality of memory-access operations, based on at least one of a determination that a count of dimensions of the first loop is less than a count of dimensions supported by the same AGU, a determination that the plurality of memory-access operations have no bounds and no pass-throughs, or a determination that differences between consecutive offsets of the plurality of memory-access operations are the same.

54. The product of claim 40, wherein the AGU configuration code comprises code to configure the same AGU according to a time-shift scheme, the time-shift scheme configured to implement the plurality of memory-access operations as a plurality of time-shifted memory-access operations of the same AGU during a plurality of respective loop iterations.

55. The product of claim 54, wherein the AGU configuration code comprises a loop-interchange instruction for a dimension of the AGU corresponding to the loop, wherein the loop-interchange instruction is configured to instruct a loop interchange between the dimension of the AGU corresponding to the loop and another dimension of the AGU corresponding to an outer loop.

56. The product of claim 54, wherein the instructions, when executed, cause the compiler to configure the AGU configuration code comprising a loop-interchange instruction for a dimension of the AGU corresponding to the loop, based on a determination that a difference between the first offset and the second offset is based on a dimension of an other loop comprising the loop, wherein the loop-interchange instruction is configured to instruct a loop interchange between the dimension of the AGU corresponding to the loop and another dimension of the AGU corresponding to the other loop.

57. The product of claim 54, wherein the AGU configuration code is configured to set a same count parameter for all AGUs to perform memory-access operations during the loop, wherein the same count parameter is based on a count parameter of the loop, a maximal offset of the plurality of memory-access operations, and a minimal offset of the plurality of memory-access operations.

58. The product of claim 57, wherein the AGU configuration code is to set the same count parameter, denoted Count, as follows:
$$Count = Align Up To ( ( MaxXOffset - MinXOffset ) + Count ( Loop ) , VF ) / VF$$
wherein MaxXOffset denotes the maximal offset of the plurality of memory access operations,
wherein MinXOffst denotes the minimal offset of the plurality of memory access operations,
wherein VF denotes a vectorization factor,
wherein Count (Loop) denotes the count parameter of the loop, and
wherein the operation AlignUpTo(a,b) is to align-up a to an integer multiple of b.

59. The product of claim 54, wherein the instructions, when executed, cause the compiler to generate loop code based on the loop, and pre-header code to be executed before a header of the loop code, wherein the target code is based on the loop code and the pre-header code, wherein the pre-header code comprises a plurality of AGU load instructions to be executed by the same AGU, wherein a count of AGU load instructions in the plurality of AGU load instructions is based on a count of memory-access operations in the plurality of memory-access operations.

60. The product of claim 59, wherein the loop code comprises a plurality of store instructions to store results of a respective plurality of AGU load iterations by the same AGU, wherein a count of the plurality of store instructions is based on the count of memory-access operations in the plurality of memory-access operations.

61. The product of claim 60, wherein the plurality of store instructions is configured to cause the target processor to store a plurality of load results of the plurality of AGU load instructions in the pre-header code at a first-in-order iteration of the plurality of AGU load iterations.

62. The product of claim 54, wherein the instructions, when executed, cause the compiler to configure the AGU configuration code comprising code to configure the same AGU according to the time-shift scheme, based on at least one of a determination that the plurality of memory-access operations comprises only load operations, a determination that differences between consecutive offsets of the plurality of memory-access operations are independent of a dimension of the loop, a determination that the plurality of memory-access operations have no bounds and no pass-throughs, a determination that the plurality of memory-access operations are not masked, or a determination that the loop does not comprise any side effects.

63. A computing system comprising:
at least one memory to store instructions; and
at least one processor to retrieve the instructions from the memory and to execute the instructions to cause the computing system to:
identify a plurality of memory-access operations in a loop based on a source code to be compiled into a target code to be executed by a target processor, the plurality of memory-access operations comprising at least a first memory-access operation and a second memory-access operation to a same memory pointer, wherein the first memory-access operation has a first offset, the second memory-access operation has a second offset different from the first offset;
configure Address Generation Unit (AGU) configuration code to configure the plurality of memory-access operations by a same AGU; and
generate the target code based on compilation of the source code, wherein the target code is based on the AGU configuration code.

64. The computing system of claim 63 comprising the target processor to execute the target code, the target processor comprising a vector processor.
